(19) United States
(12) Patent Application Publication
(10) Pub. No.: US 2009/0195188 A1
(43) Pub. Date: Aug. 6, 2009

(54) COLD-CATHODE FLUORESCENT LAMP HAVING THIN COAT AS ELECTRICALLY CONNECTED TERMINAL, PRODUCTION METHOD OF THE LAMP, LIGHTING APPARATUS HAVING THE LAMP, BACKLIGHT UNIT, AND LIQUID CRYSTAL DISPLAY APPARATUS

(76) Inventors: Takashi Maniwa, Takatsuki-shi (JP); Toshihiro Terada, Amagasaki-shi (JP); Akiko Nakanishi, Takatsuki-shi (JP); Taizou Ono, Hirakata-shi (JP); Kazuhiro Kumada, Himeji-shi (JP); Tadao Mori, Fukuchiyama-shi (JP); Tomokazu Matsuura, Osaka-shi (JP)

Correspondence Address: SNELL & WILMER L.L.P. (Panasonic), 600 ANTON BOULEVARD, SUITE 1400, COSTA MESA, CA, 92626, US

(21) Appl. No.: 12/423,730

(22) Filed: Apr. 14, 2009

Related U.S. Application Data
(62) Division of application No. 11/375,560, filed on Mar. 14, 2006.

(30) Foreign Application Priority Data
Mar. 15, 2005 (JP) 2005-073681
Jun. 20, 2005 (JP) 2005-178786
Dec. 7, 2005 (JP) 2005-352989
Dec. 7, 2005 (JP) 2005-352990
Feb. 16, 2006 (JP) 2006-039868

(51) Int. Cl. H05B 41/36; H01J 61/06

(52) U.S. Cl. 315/294; 313/607; 349/70; 362/97.2

(57) ABSTRACT

A cold-cathode fluorescent lamp including a glass bulb, a pair of hollow electrodes, and a pair of electrically connected terminals. The hollow electrodes each include an electrode body and a lead wire. The hollow electrodes are hermetically connected to the glass bulb at both ends of the glass bulb. The pair of electrically connected terminals are thin coats that are, except for connection portions connected to lead wires, provided on an outer surface of the glass bulb at both ends of the glass bulb.

This application is based on application No. 2005-073681, 2005-178786, 2005-352989, 2005-352990 and 2006-039868 filed in Japan, the contents of which are hereby incorporated by reference.

### BACKGROUND OF THE INVENTION

(1) Field of the Invention

The present invention relates to a cold-cathode fluorescent lamp, a production method of the lamp, a lighting apparatus having the lamp, a backlight unit, and a liquid crystal display apparatus.

(2) Description of the Related Art

There has been known a cold-cathode fluorescent lamp 200 that is, as shown in FIG. 1, composed of a glass bulb 201 and an electrically connected terminal 202 that is in the shape of a cap and is attached to an end of the glass bulb 201 (Japanese Laid-Open Patent Application No. 7-220622). The electrically connected terminal 202 is electrically connected to a lead wire 204 of an electrode 203. With this construction, it is possible, by fitting the end of the cold-cathode fluorescent lamp 200 into a lamp holder (not illustrated) of a lighting apparatus such as a backlight unit, to fix the cold-cathode fluorescent lamp 200 to the lighting apparatus, and to electrically connect the cold-cathode fluorescent lamp 200 to an electric ballast of the lighting apparatus. This construction eliminates the need of soldering the lead wire 204 when attaching the cold-cathode fluorescent lamp 200 to the lighting apparatus. This provides an easier attachment of the lamp, compared with an attachment of a cold-cathode fluorescent lamp to which the electrically connected terminal 202 has not been attached.

There has been also known a cold-cathode fluorescent lamp 300 that, as shown in FIG. 2, includes what is called a hollow electrode 303 that is composed of: an electrode body 301 in the shape of a cylinder with a bottom; and a lead wire 302 (Japanese Laid-Open Patent Application No. 2002-289138). In cold-cathode fluorescent lamp 300, as shown in the arrows in FIG. 2, a discharge occurs within the electrode body 301. This construction ensures a relatively long life of the lamp since it prevents the material sputtered by the discharge from attaching to the inner surface of a glass bulb 304.

Meanwhile, in the cold-cathode fluorescent lamp 200 that includes the electrically connected terminal 202 as shown in FIG. 1, it is also preferable to adopt the hollow electrode to obtain a long life, but in the actuality, the life is shortened if it adopts the hollow electrode. The reason is as follows.

When an electrode body 205 is in the shape of a rod, the discharge occurs at the entire outer surface of the electrode body 205 as indicated by the arrows in FIG. 1. When this happens, part of the discharge goes around and reaches the lead wire 204 to heat the lead wire 204 and its surroundings. Accordingly, if the electrically connected terminal 202 functions as a heat sink that decreases the temperature of the lead wire 204, it does not decrease the temperature of the lead wire 204 and its surroundings sufficiently.

On the other hand, in the case of the hollow electrode, the chance of the discharge going around and reaching the lead wire 204 to heat the lead wire 204 is small. As a result, the lead wire 204 and its surroundings are heated less frequently. And therefore, it overly decreases the temperature of the lead wire 204 and its surroundings by the thermolytic action of the electrically connected terminal 202. This results in a large amount of mercury vapor gathering around the lead wire 204, causing a shortage of mercury vapor in the discharge path, and when this happens, the lamp brightness is decreased.

### SUMMARY OF THE INVENTION

The main object of the present invention is therefore to provide a cold-cathode fluorescent lamp that is easy to attach, has a long life, and has sufficient lamp brightness.

The above object is fulfilled by a cold-cathode fluorescent lamp comprising: a glass bulb; a pair of hollow electrodes which each include an electrode body and a lead wire and are hermetically connected to the glass bulb at both ends of the glass bulb; and a pair of electrically connected terminals being thin coats that are, except for connection portions thereof connected to lead wires, provided on an outer surface of the glass bulb at both ends thereof.

In the above-stated construction, the electrically connected terminals are thin coats that are, except for connection portions connected to lead wires, provided on the outer surface of the glass bulb at both ends of the glass bulb. With this construction, the outer surface area of the electrically connected terminals is small, and therefore has a small thermolytic action, compared with conventional electrically connected terminals. This makes the temperature of the lead wires difficult to fall, and makes mercury vapor difficult to gather around the lead wires, preventing the lamp brightness of the cold-cathode fluorescent lamp from reducing due to the shortage of mercury vapor in the discharge path.

In the above-described cold-cathode fluorescent lamp, the thin coats may be 5 μm to 120 μm in thickness.

The reason for the above construction is that if the thickness of the electrically connected terminal is smaller than 5 μm, removability of the thin coat from the glass bulb reaches to an extent of uselessness in the practical use. On the other hand, if the thickness of the electrically connected terminal is larger than 120 μm, the outer surface area of the electrically connected terminal becomes excessively large and the thermolytic action of the electrically connected terminal becomes excessively large. When this happens, the temperature of the lead wire of the electrode is apt to be lower than that of the conventional cold-cathode fluorescent lamps. And when this happens, a sufficient lamp brightness may not be obtained.

In the above-described cold-cathode fluorescent lamp, the lead wire may include a projection portion projecting from the outer surface of the glass bulb in a direction of a tube axis of the glass bulb, the projection portion being connected to one of the electrically connected terminals and being 1 mm or less in length in the direction of the tube axis.

With the above-stated construction, the outer lead wire is not an excessive protrusion for the whole cold-cathode fluorescent lamp of a typical size which will be described later. The outer lead wire of this size has resistance to bending, damage and the like which may occur when it is bumped against something, and the sealing portion of the lead wire is difficult to break if a stress is given to the outer lead wire when the outer lead wire is bent.

In the above-described cold-cathode fluorescent lamp, in the electrically connected terminals, at least the connection portions may be made of solder.

With the above-stated construction, the electrically connected terminal can be formed by a known dipping method or the like. In particular, when the entire electrically connected terminal is made of solder, the aforementioned dipping method is convenient for forming the electrically connected terminal. As a result, compared with a conventional electrically connected terminal which is assembled from parts, the electrically connected terminal of the present invention makes it possible to manufacture the cold-cathode fluorescent lamp easily and at low cost. In addition, generally, solder has lower thermal conductivity than the iron-nickel alloy, which is typically used for a cap-shaped electrically connected terminal. This prevents decrease of the lamp brightness.

In the above-described cold-cathode fluorescent lamp, in each lead wire, at least one part that is connected to a electrically connected terminal may include a block that has an outer diameter larger than an outer diameter of an electrode-body-side portion of the lead wire, and is in close contact with the outer surface of the glass bulb.

In the above-stated construction, the electrically connected terminals are thin coats that are, except for connection portions connected to lead wires, provided on the outer surface of the glass bulb at both ends of the glass bulb. With this construction, the outer surface area of the electrically connected terminals is small, and therefore has a small thermolytic action, compared with conventional electrically connected terminals. This makes the temperature of the lead wires difficult to fall, and makes mercury vapor difficult to gather around the lead wires, preventing the lamp brightness of the cold-cathode fluorescent lamp from reducing due to the shortage of mercury vapor in the discharge path. Also, the block having an outer diameter larger than an outer diameter of an electrode-body-side portion of the lead wire is in close contact with the outer surface of the glass bulb, at each end of the glass bulb. This construction enables the distance between the block and the hollow electrode to be constant. That is to say, it is possible to make a distance between the bottom outer surface of the hollow electrode and the inner surface of the glass bulb small to elongate an effective light-emission length. This construction also enables a force, that is applied to the block when the projecting portion of the outer lead wire is bumped against something outside, to be absorbed by the end of the glass bulb. Accordingly, this construction prevents the sealing portions of the glass bulb to which the inner lead wires are hermetically connected from being broken, thus preventing leakage of the inner contents.

In the above-described cold-cathode fluorescent lamp, in the lead wire, at least one part that is hermetically connected to the glass bulb may be made of a material that has approximately a same thermal expansion coefficient as a glass of which the glass bulb is made, and part or all of the block is made of nickel.

Alternatively, in the above-described cold-cathode fluorescent lamp, in the lead wire, at least one part that is hermetically connected to the glass bulb may be made of a material that has approximately a same thermal expansion coefficient as a glass of which the glass bulb is made, and part or all of the block is plated with nickel.

The above-stated construction, in which part or all of the block is made of nickel or plated with nickel, ensures the solder-connection of the lead wires to the electrically connected terminals.

In the above-described cold-cathode fluorescent lamp, the block may be embedded in one end of the glass bulb.

The above-stated construction, in which the block is embedded in an end of the glass bulb, further enables the force, that is applied to the block when the projecting portion of the outer lead wire is bumped against something outside, to be absorbed by the end of the glass bulb. Accordingly, this construction prevents the sealing portions of the glass bulb to which the inner lead wires are hermetically connected from being broken, thus preventing leakage of the inner contents.

In the above-described cold-cathode fluorescent lamp, the block may be approximately circular in a cross section, and the outer diameter of the block is 1.5 to 4 times the outer diameter of the electrode-body-side portion of the lead wire.

The above-stated construction, in which the block is approximately circular in a cross section and the outer diameter of the block is 1.5 to 4 times the outer diameter of the electrode-body-side portion of the lead wire, further enables the force, that is applied to the block when the projecting portion of the outer lead wire is bumped against something outside, to be absorbed by the end of the glass bulb. Accordingly, this construction prevents the sealing portions of the glass bulb to which the inner lead wires are hermetically connected from being broken, thus preventing leakage of the inner contents.

In the above-described cold-cathode fluorescent lamp, the glass bulb may be made of soda glass in which a rate of content of sodium oxide is 3% to 20%.

With the above-stated construction, the start-up characteristics in dark surrounding are improved.

The glass bulb may be made of soda glass in which a rate of content of sodium oxide is 5% to 20%.

With the above-stated construction, the start-up time in dark surrounding are improved to approximately one second or less.

In the above-described cold-cathode fluorescent lamp, in the glass bulb, a light extraction portion of a positive column light emitting portion may be in a flattened shape in a cross section, and at least portions including the hollow electrodes are in a shape of a circle in a cross section, and the light extraction portion maybe longer than each of the portions including the hollow electrodes in the direction of the tube axis of the glass bulb.

With the above-stated construction, it is possible to suppress an excessive increase of the coldest-part temperature by causing the lamp to have a larger outer surface area than conventional straight-tube lamps. Also, since the minimum inner diameter of the flattened portion is shorter than the maximum inner diameter that is approximately equal to the inner tube diameter of the conventional straight-tube lamps, it is possible to maintain the distance between the center of the positive column plasma space and the tube inner wall to be effectively short. This makes it possible to have a larger lamp current than the conventional lamps, and at the same time makes the light emission efficiency difficult to decrease.

In the above-described cold-cathode fluorescent lamp, each of the electrically connected terminals may include: a body layer that is formed on the outer surface of the glass bulb, and a major component thereof is silver or copper; and an outer layer that is formed on an outer surface of the body layer.

With the above-stated construction, in which the body layer of the electrically connected terminal has high electric conductivity since it is mainly made of a metal such as silver or copper that has small electric resistance, and the outer layer is formed on the outer surface of the body layer, the body layer is difficult to be exposed to the atmospheric air, and sulphurization of silver or oxidization of copper is difficult to occur, and thus reduction of conductivity is difficult to occur. As a result, it is possible to make the connectability between the electrically connected terminal and the lead wire of the electrode excellent. Also, it makes the electrically connected terminal resistant to flaws or cracks when the cold-cathode fluorescent lamp is installed in a lamp holder.

In the above-described cold-cathode fluorescent lamp, an end of the outer layer on a side of a center of the glass bulb may be disposed with a distance away from an end of the body layer on the side of the center of the glass bulb, towards an end of the glass bulb opposite to the center of the glass bulb.

With the above-stated construction, in which an end of the outer layer on a side of a center of the glass bulb is disposed with a distance away from an end of the body layer on the side of the center of the glass bulb, towards an end of the glass bulb opposite to the center of the glass bulb, it is possible to prevent the corona discharge from occurring in a space between the outer layer and the glass bulb during lamp lighting, reducing the amount of generated ozone.

In the electrically connected terminal, the combined thickness of the body layer and the outer layer may be 5 μm to 120 μm in thickness.

The reason is that if the thickness of the electrically connected terminal is smaller than 5 μm, removability of the thin coat from the glass bulb reaches to an extent of uselessness in the practical use. On the other hand, if the thickness of the electrically connected terminal is larger than 120 μm, the outer surface area of the electrically connected terminal becomes excessively large and the thermolytic action of the electrically connected terminal becomes excessively large. When this happens, the temperature of the lead wire of the electrode is apt to be lower than that of the conventional cold-cathode fluorescent lamps. And when this happens, a sufficient lamp brightness may not be obtained.

The outer layer may be mainly made of solder.

With this construction in which the outer layer of the electrically connected terminal is mainly made of solder, the outer layer is resistant to corrosion or deterioration. This elongates the life of the electrically connected terminal.

In the above-described cold-cathode fluorescent lamp, end portions of the electrically connected terminals on a side of a center of the glass bulb may become smaller in thickness as the end portions are closer to the center of the glass bulb.

With the above-stated construction in which the end portions of the electrically connected terminals become thinner as they come closer to the center of the glass bulb, it is possible to prevent the corona discharge from occurring in a space between the end portions of the electrically connected terminals and the glass bulb during lamp lighting, reducing the amount of generated ozone.

In the above-described cold-cathode fluorescent lamp, end portions of the electrically connected terminals on a side of a center of the glass bulb may be in a shape of an arc projecting outside and may become smaller in thickness as the end portions are closer to the center of the glass bulb.

The above-stated construction increase the strength of the end portions of the electrically connected terminals, and makes the electrically connected terminals difficult to remove from the glass bulb.

A lighting apparatus of the present invention comprises: the above-described cold-cathode fluorescent lamp; lamp holders that are provided in a box such that a contour of the electrically connected terminals of the cold-cathode fluorescent lamp is held, and are electrically connected to the cold-cathode fluorescent lamp; and an electric ballast that is connected to the lamp holders and causes the cold-cathode fluorescent lamp to be lighted, wherein the lamp holders hold a plurality of cold-cathode fluorescent lamps each of which is the above-described cold-cathode fluorescent lamp, such that the plurality of cold-cathode fluorescent lamps are arranged substantially in parallel at regular intervals, and such that lamp holders, which hold electrically connected terminals of two cold-cathode fluorescent lamps adjacent to each other at one end in a longitudinal direction of the arranged plurality of cold-cathode fluorescent lamps, are connected to each other.

With the above-stated construction in which the plurality of cold-cathode fluorescent lamps are arranged substantially in parallel at regular intervals, and electrically connected terminals of two cold-cathode fluorescent lamps adjacent to each other at one end in a longitudinal direction of the arranged plurality of cold-cathode fluorescent lamps are connected to each other via the lamp holders, it is possible to form a pseudo-curved tube (tube in the approximate shape of character U) and reduce the number of inverters to half of before, to reduce, compared with conventional lamps having curved portions, the unevenness of brightness between the right side and the left side of the box in the longitudinal direction of the lamp, to prevent the sealing portion or the like of the cold-cathode fluorescent lamp from breaking, and to attach or detach the cold-cathode fluorescent lamp easily with a single touch. Also, with this construction in which the cold-cathode fluorescent lamps in the shape of straight tubes having electrodes at both ends thereof are arranged in parallel, for example, in the vertical direction, the electrodes as heat generating sources do not gather on the same side. This prevents the generation of a temperature difference between the right side and the left side of the box. As a result, it is possible to prevent the brightness of the backlight unit from becoming uneven, which would occur when it is affected by the mercury vapor pressure of the lamps.

In the above-described lighting apparatus, the lamp holders may be arranged in a houndstooth pattern such that lamp holders holding first two cold-cathode fluorescent lamps adjacent to each other connect electrically connected terminals of the first two cold-cathode fluorescent lamps at one end of the plurality of cold-cathode fluorescent lamps arranged in parallel, lamp holders holding second two cold-cathode fluorescent lamps adjacent to each other connect electrically connected terminals of the second two cold-cathode fluorescent lamps at another end of the plurality of cold-cathode fluorescent lamps arranged in parallel, and lamp holders holding third two cold-cathode fluorescent lamps adjacent to each other connect electrically connected terminals of the third two cold-cathode fluorescent lamps at said one end of the plurality of cold-cathode fluorescent lamps arranged in parallel.

With the above-stated construction in which the lamp holders are arranged in a houndstooth pattern as described above, it is possible to make the electric ballast smaller and reduce the harness processing.

Another lighting apparatus of the present invention comprises: the above-described cold-cathode fluorescent lamp; lamp holders that are electrically conductive and are provided in a box such that the electrically connected terminals provided at both ends of the cold-cathode fluorescent lamp are connected to each other; an electric ballast that is connected to the lamp holders and causes the cold-cathode fluorescent lamp to be lighted, wherein the lamp holders hold a plurality of cold-cathode fluorescent lamps each of which is the above-described cold-cathode fluorescent lamp, such that the plurality of cold-cathode fluorescent lamps are arranged substantially in parallel, and such that at least one of lamp holders connected to the electrically connected terminals of two cold-cathode fluorescent lamps adjacent to each other is connected to a ground connection side, and each lamp holder at another end of the plurality of cold-cathode fluorescent lamps is connected to a high-voltage side of the electric ballast.

With the above-stated construction in which electrically connected terminals of two straight-tube-type cold-cathode fluorescent lamps adjacent to each other at one end in a longitudinal direction of the arranged plurality of cold-cathode fluorescent lamps are connected to each other via the lamp holders, it is possible, as is the case of cold-cathode fluorescent lamps in the approximate shape of character U, to reduce the harness processing, and it is further possible to reduce the unevenness of brightness between the right side and the left side of the box in the longitudinal direction of the lamp, to prevent the sealing portion or the like of the cold-cathode fluorescent lamp from breaking, and to attach or detach the cold-cathode fluorescent lamp easily with a single touch. Also, with this construction in which the cold-cathode fluorescent lamps in the shape of straight tubes having electrodes at both ends thereof are arranged in parallel, for example, in the vertical direction, the electrodes as heat generating sources do not gather on the same side. This prevents the generation of a temperature difference between the right side and the left side of the box. As a result, it is possible to prevent the brightness of the backlight unit from becoming uneven, which would occur when it is affected by the mercury vapor pressure of the lamps.

In the above-described lighting apparatus, a phase difference between voltages applied to adjacent two lamp holders connected to the high-voltage side of the electric ballast may be approximately 0 degree.

With the above-stated construction in which a phase difference between voltages applied to adjacent two lamp holders connected to the high-voltage side of the electric ballast may be approximately 0 degree, it is possible to shorten the distance between two adjacent straight-tube-type cold-cathode fluorescent lamps, compared with the case where the phase difference is approximately 180 degrees.

A backlight unit of the present invention comprises the above-described cold-cathode fluorescent lamp as a light source.

With the above-stated construction in which the above-described cold-cathode fluorescent lamp is installed as a light source, the lamp is easy to attach, has a long life, and has sufficient lamp brightness.

A liquid crystal display apparatus of the present invention comprises the above-described backlight unit.

With the above-stated construction of the liquid crystal display apparatus in which the above-described lighting apparatus is installed, it is possible to form a pseudo-curved tube (tube in the approximate shape of character U) and reduce the number of inverters to half of before, to reduce, compared with conventional lamps having curved portions, the unevenness of brightness between the right side and the left side of the box in the longitudinal direction of the lamp, to prevent the sealing portion or the like of the cold-cathode fluorescent lamp from breaking, and to attach or detach the cold-cathode fluorescent lamp easily with a single touch. Also, with this construction in which the cold-cathode fluorescent lamps in the shape of straight tubes having electrodes at both ends thereof a rearranged in parallel, for example, in the vertical direction, the electrodes as heat generating sources do not gather on the same side. This prevents the generation of a temperature difference between the right side and the left side of the box. As a result, it is possible to prevent the brightness of the backlight unit from becoming uneven, which would occur when it is affected by the mercury vapor pressure of the lamps.

### BRIEF DESCRIPTION OF THE DRAWINGS

These and the other objects, advantages and features of the invention will become apparent from the following description thereof taken in conjunction with the accompanying drawings which illustrate a specific embodiment of the invention.

In the drawings:

FIG. 1 shows an end of a conventional cold-cathode fluorescent lamp, provided with a cap-shaped electrically connected terminal;

FIG. 2 shows an end of a conventional cold-cathode fluorescent lamp, provided with a hollow electrode;

FIG. 3 is a cutaway perspective view showing a cold-cathode fluorescent lamp in Embodiment 1;

FIG. 4 is an enlarged cross section showing an end of the cold-cathode fluorescent lamp in Embodiment 1;

FIG. 5 is an enlarged cross section of an end portion of the cold-cathode fluorescent lamp of Modification 1 of Embodiment 1;

FIG. 6 is an enlarged cross section of an end portion of the cold-cathode fluorescent lamp of Modification 2 of Embodiment 1;

FIG. 7 is an enlarged cross section of an end portion of the cold-cathode fluorescent lamp of Modification 3 of Embodiment 1;

FIG. 8 is an enlarged cross section of an end portion of the cold-cathode fluorescent lamp of Modification 4 of Embodiment 1;

FIG. 9 is a perspective view of a thin coat member of the electrically connected terminal;

FIG. 10 is a cutaway perspective view showing a cold-cathode fluorescent lamp in Embodiment 2;

FIG. 11 is an enlarged cross section showing an end of the cold-cathode fluorescent lamp in Embodiment 2;

FIG. 12 is an enlarged cross section of an end portion of the cold-cathode fluorescent lamp of Modification 1 of Embodiment 2;

FIG. 13 is an enlarged cross section of an end portion of the cold-cathode fluorescent lamp of Modification 2 of Embodiment 2;

FIG. 14 is an enlarged cross section of an end portion of the cold-cathode fluorescent lamp of Modification 3 of Embodiment 2;

FIG. 15A is a cross section of a cold-cathode fluorescent lamp in Embodiment 3;

FIG. 15B is a cross section taken along the line B-B in FIG. 15A;

FIG. 15C is a cross section taken along the line C-C in FIG. 15A;

FIG. 15D is a cross section taken along the line D-D in FIG. 15A;

FIG. 16A is a cross section of another cold-cathode fluorescent lamp in Embodiment 3;

FIG. 16B shows an appearance of the metal member;

FIG. 16C is a cross section taken along the line B-B in FIG. 16A;

FIG. 16D is a cross section taken along the line C-C in FIG. 16A;

FIG. 16E is a cross section taken along the line D-D in FIG. 16A;

FIG. 17 shows the temperature characteristics of the cold-cathode fluorescent lamp;

FIG. 18 shows the relationship between the thickness of the thin coat member of the electrically connected terminal and the temperature near the electrode;

FIG. 19 is an exploded perspective view showing an outline construction of the backlight unit and the like in Embodiment 1 of the present invention;

FIG. 20 shows how the cold-cathode fluorescent lamp is attached;

FIG. 21 is a plan view of a conventional backlight unit without its attachment frame and translucent panel;

FIG. 22 is a perspective view of a backlight unit 912 in Embodiment 2;

FIG. 23 is a perspective view of a lighting apparatus of the present invention;

FIG. 24A shows an electric ballast provided in a lighting apparatus of the present invention;

FIG. 24B shows a pattern of connections between a plurality of cold-cathode fluorescent lamps connected to the electric ballast;

FIG. 24C shows another pattern of connections between a plurality of cold-cathode fluorescent lamps connected to the electric ballast;

FIG. 25 is a perspective view of a lighting apparatus of a modification of the present invention;

FIG. 26A shows an electric ballast provided in a lighting apparatus of a modification of the present invention;

FIG. 26B shows a pattern of connections between a plurality of cold-cathode fluorescent lamps connected to the electric ballast; and

FIG. 27 shows an outline of a liquid crystal display apparatus in Embodiment 1 of the present invention.

### DESCRIPTION OF THE PREFERRED EMBODIMENT

The following describes a cold-cathode fluorescent lamp, a production method of the lamp, a lighting apparatus having the lamp, a backlight unit, and a liquid crystal display apparatus as embodiments of the present invention, with reference to the attached drawings.

<Cold-cathode fluorescent Lamp>

### Embodiment 1

### Cold-Cathode Fluorescent Lamp

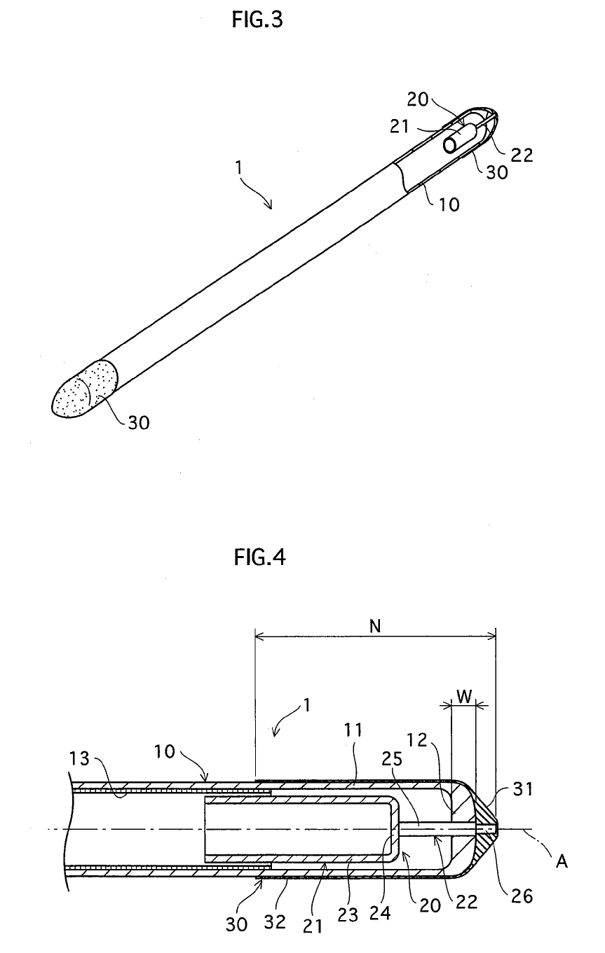

FIG. 3 is a cutaway perspective view showing a cold-cathode fluorescent lamp 1 in Embodiment 1. FIG. 4 is an enlarged cross section showing an end of the cold-cathode fluorescent lamp 1. The cold-cathode fluorescent lamp 1 is used as a light source of a backlight unit, and includes a glass bulb 10, a pair of hollow electrodes 20 that are respectively hermetically connected to the glass bulb 10 at both ends of the glass bulb 10, and electrically connected terminals 30 that are respectively provided on the outer surface of the glass bulb 10 at both ends thereof.

The glass bulb 10 is made from a glass tube that is made of borosilicate glass (SiO₂—B₂O₃—Al₂O₃—K₂O—TiO₂), and is 730 mm in length.

The glass bulb 10 includes a tubular glass bulb body 11, and a pair of sealing portions 12 positioned at both ends in the longitudinal direction of the glass bulb body 11.

The glass bulb body 11 is annular in the cross section, and is 4 mm in outer diameter, 3 mm in inner diameter, and 0.5 mm in thickness. The sealing portion 12 is, as shown in FIG. 4, 2 mm in maximum width W in the direction of tube axis A of the glass bulb 10. The hollow electrode 20 is hermetically connected to the sealing portion 12.

The glass bulb 10 is not limited to the above-stated construction. However, to make the cold-cathode fluorescent lamp 1 spindly, it is preferable that the glass bulb 10 has a small diameter and a small thickness. In general, it is preferable that the glass bulb body 11 is 1.8 mm to 6.0 mm in outer diameter (1.4 mm to 5.0 mm in inner diameter).

A phosphor layer 13 is formed on the inner surface of the glass bulb 10. The phosphor layer 13 is made of a rare-earth phosphor that is made by mixing: red phosphor (Y₂O₃:Eu); green phosphor (LaPO₄:Ce, Tb); and blue phosphor (BaMg₂Al₁₆O₂₇:Eu, Mn). Further, the inner space of the glass bulb 10 is filled with approximately 1200 μg of mercury and a neon-argon mixture gas (Ne:95%+Ar:5%) of approximately 8 kPa (20° C.) as a rare gas.

It should be noted here that the constructions of the phosphor layer 13, mercury, and rare gas are not limited to the above-described ones. For example, the inner space of the glass bulb 10 may be filled with a neon-krypton mixture gas (Ne:95%+Kr:5%) as a rare gas. Using a neon-krypton mixture gas as a rare gas improves the start-up characteristics of the lamp and enables the cold-cathode fluorescent lamp 1 to be lighted with a low voltage.

The hollow electrode 20 includes an electrode body 21 and a lead wire 22, and is hermetically connected to the sealing portion 12 of the glass bulb 10. The construction in which the electrodes are the hollow electrodes 20 reduces the amount of material that is sputtered by the discharge and attached to the inner surface of the glass bulb, and reduces consumption of mercury.

The electrode body 21 is made of nickel (Ni), is in the shape of a cylinder with a bottom, and includes a cylinder portion 23 and a bottom portion 24. The material of the electrode body 21 is not limited to nickel, and the electrode body 21 may be made of, for example, niobium (Nb), tantalum (Ta), or molybdenum (Mo).

The cylinder portion 23 is 5.2 mm length, 2.7 mm in outer diameter, 2.3 mm in inner diameter, and 0.2 mm in thickness. The hollow electrode 20 is arranged such that the tube axis of the cylinder portion 23 substantially matches the tube axis of the glass bulb 10, and such that the distance between the outer circumferential surface of the cylinder portion 23 and the inner surface of the glass bulb 10 is approximately constant all over the outer circumferential surface of the cylinder portion 23.

The distance between the outer circumferential surface of the cylinder portion 23 and the inner surface of the glass bulb 10 is 0.15 mm, as one example. When this distance is as small as 0.15 mm, the discharge does not enter the space between the outer circumferential surface of the cylinder portion 23 and the inner surface of the glass bulb 10, and the discharge occurs only inside the hollow electrode 20. This construction accordingly provides a long life of the cold-cathode fluorescent lamp 1 since it prevents the material sputtered by the discharge from attaching to the inner surface of the glass bulb 10. On the other hand, the discharge does not go around to the lead wire 22 side. This prevents the lead wire 22 from being heated by the discharge, and contributes to the long life of the cold-cathode fluorescent lamp 1.

The distance between the outer circumferential surface of the cylinder portion 23 and the inner surface of the glass bulb 10 is not limited to 0.15 mm, but preferably may be 0.2 mm or less so as to prevent the discharge from entering the space therebetween.

The lead wire 22 is formed by linking an inner lead wire 25 made of tungsten (W) with an outer lead wire 26 made of nickel that can easily attach to solder or the like. The lead wire 22 extends straight along the tube axis direction of the glass bulb 10. The bonding plane of the inner lead wire 25 and the outer lead wire 26 substantially matches the plane of the outer surface of the glass bulb 10. That is to say, the inner lead wire 25 is inside the outer surface of the glass bulb 10, and the outer lead wire 26 is outside the outer surface of the glass bulb 10.

The inner lead wire 25 is approximately circular in the cross section, and is 3 mm in length and 0.8 mm in diameter. An end of the inner lead wire 25 on the outer lead wire 26 side is hermetically connected to the sealing portion 12 of the glass bulb 10, and the other end thereof opposite to the outer lead wire 26 is connected to the bottom portion 24 of the electrode body 21 at approximately the center of the outer surface thereof.

The outer lead wire 26 protrudes from the outer surface of the glass bulb 10 in the tube axis A direction, and is connected to the electrically connected terminal 30. The outer lead wire 26 is 1 mm in length, and the axis of the outer lead wire 26 substantially matches the tube axis A of the glass bulb 10. Therefore, the length of the outer lead wire 26 in the tube axis A direction is 1 mm. The outer lead wire 26 is approximately circular in the cross section, and is 0.6 mm in diameter, namely, smaller than the inner lead wire 25 in diameter.

A preferable length of the outer lead wire 26 in the tube axis A direction is 1 mm or less. As described earlier, to make the cold-cathode fluorescent lamp 1 spindly, it is preferable that the glass bulb body 11 is 1.8 mm to 6.0 mm in outer diameter. If the outer lead wire 26 has a length of 1 mm or less in the tube axis A direction in the cold-cathode fluorescent lamp 1 of this size, the outer lead wire 26 is not an excessive protrusion for the cold-cathode fluorescent lamp 1 as a whole. The outer lead wire 26 of this size has resistance to bending, damage and the like which may occur when it is bumped against something. For example, the outer lead wire 26 of this size is difficult to bend if it is bumped against the backlight unit 100 when the cold-cathode fluorescent lamp 1 is attached to the backlight unit 100. And the sealing portion 12 is difficult to break if a stress is given to the outer lead wire 26 when the outer lead wire 26 is bumped against the backlight unit 100.

The electrically connected terminals 30 are respectively provided at opposite ends of the glass bulb 10 to cover the end portions. The electrically connected terminal 30 is made of solder, and is composed of: a connection portion 31 that is connected to the outer lead wire 26; and a thin coat portion 32 being the remaining portion.

That is to say, the electrically connected terminal 30 is electrically connected to the lead wire 22 at the connection portion 31. The connection portion 31 has an approximate appearance of circular cone. For this reason, the area of the outer surface of the connection portion 31 is small even though it entirely covers the outer surface of the outer lead wire 26. The area of the outer surface of the electrically connected terminal 30 is also small, and the thermolytic action is small. As a result, the temperature of the lead wire 22 is difficult to decrease. Also, since the outer surface of the outer lead wire 26 is entirely covered with the electrically connected terminal 30, the outer lead wire 26 is difficult to bend, and the sealing portion 12 is difficult to break if a stress is given to the outer lead wire 26. It is preferable that the area of the outer surface of the connection portion 31 is as small as possible.

The thin coat portion 32 is formed in a predetermined area on the outer surface of the glass bulb body 11 on the sealing portion 12 side, and is formed in a predetermined area on the outer surface of the sealing portion 12 on the glass bulb body 11 side. To suppress the thermolytic action of the electrically connected terminal 30, it is preferable that the area in which the thin coat portion 32 is formed is as small as possible. Depending on the thickness of the thin coat portion 32, the length N of the electrically connected terminal 30 in the tube axis direction A is 19 mm or less. Furthermore, in the electrode body 21, the light-emitting portion of the lamp is located on the side of the center of the glass bulb body 11, not on the side of the sealing portion 12. Accordingly, when the loss of the lumen due to the electrically connected terminal 30 is taken into consideration, it is more preferable that the length N is 10 mm or less.

The electrically connected terminal 30 may be formed by a known dipping method (refer to, for example, Japanese Laid-Open Patent Application No. 2004-146351). Here, how the electrically connected terminal 30 is formed by the dipping method will be briefly explained. For example, the electrically connected terminal 30 can be formed by soaking the sealing portion 12 of the glass bulb 10, to which the hollow electrode 20 is hermetically connected, into solder fusion in a melting tank. Ultrasonic wave may be added when the sealing portion 12 is soaked into the solder fusion. Such dipping method enables the electrically connected terminal 30 to be easily and less expensively formed, contributing to reduction in the manufacturing cost of the cold-cathode fluorescent lamp 1.

The electrically connected terminal 30 may be formed by a method other than the dipping method. For example, the electrically connected terminal 30 may be formed by the vapor deposition method or by the plating.

The construction of the electrically connected terminal 30 is not limited to the above-described one, but may be, for example, any of the constructions of the Modifications 1 to 4 shown below. Basically, the cold-cathode fluorescent lamp of the Modifications 1 to 4 has the same construction as the cold-cathode fluorescent lamp 1 of Embodiment 1 except for the construction of the electrically connected terminals and electrodes. The following description therefore focuses on the differences from Embodiment 1, and the common elements are assigned the same reference signs as in Embodiment 1 and description thereof is omitted.

FIG. 5 is an enlarged cross section of an end portion of the cold-cathode fluorescent lamp of Modification 1 of Embodiment 1. An electrically connected terminal 51 of a cold-cathode fluorescent lamp 50 shown in FIG. 5 is composed of a connection portion 52 and a thin coat portion 53. The connection portion 52 has an approximate appearance of hemisphere, and entirely covers the outer surface of the outer lead wire 26. Since the outer surface of the outer lead wire 26 is entirely covered with the electrically connected terminal 52, and the end of the cold-cathode fluorescent lamp 50 is smoothly rounded by the electrically connected terminal 52, the outer lead wire 26 is difficult to bend, and the sealing portion 12 is difficult to break if the end of the cold-cathode fluorescent lamp 50 is bumped against something.

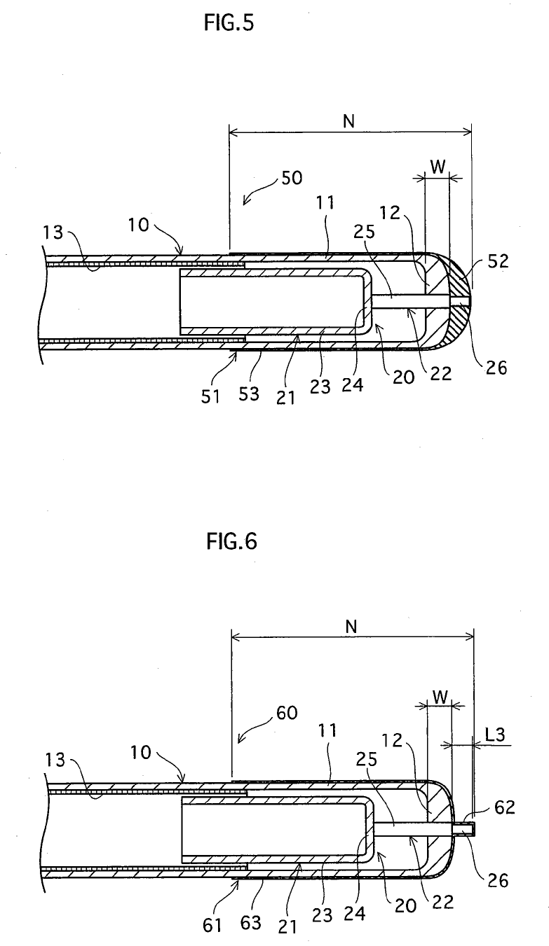

FIG. 6 is an enlarged cross section of an end portion of the cold-cathode fluorescent lamp of Modification 2 of Embodiment 1. An electrically connected terminal 61 of a cold-cathode fluorescent lamp 60 shown in FIG. 6 is composed of a connection portion 62 and a thin coat portion 63. The connection portion 62 is a thin coat and covers the entire outer surface of the outer lead wire 26. The thickness of the connection portion 62 is 10 μm, which is the same as that of the thin coat portion 63. Such a construction, in which the entire electrically connected terminal 30 is a thin coat, reduces the use amount of solder, contributing to reduction in the manufacturing cost of the cold-cathode fluorescent lamp 60.

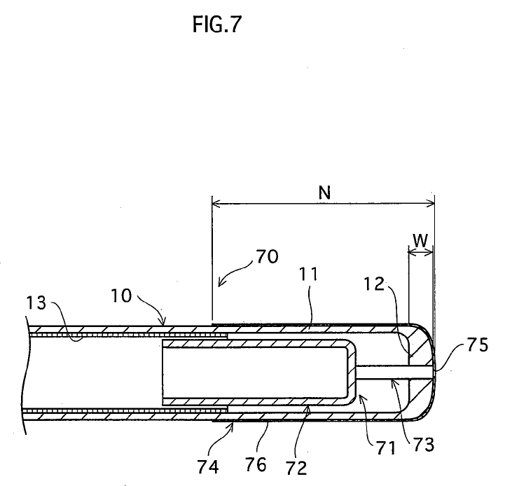

FIG. 7 is an enlarged cross section of an end portion of the cold-cathode fluorescent lamp of Modification 3 of Embodiment 1. An electrode 71 of a cold-cathode fluorescent lamp 70 shown in FIG. 7 is composed of an electrode body 72 and a lead wire 73 that is made of tungsten and is connected to the electrode body 72. The lead wire 73 lacks a portion that corresponds to the outer lead wire 26 of the lead wire 22 in Embodiment 1, and is composed only a portion that corresponds to the inner lead wire 25. The electrode 71 is hermetically connected to the sealing portion 12 of the glass bulb 10 such that the plane of the end surface of the lead wire 73 substantially matches the plane of the outer surface of the glass bulb 10.

On the other hand, an electrically connected terminal 74 is composed of a connection portion 75 and a thin coat portion 76. The connection portion 75 is a thin coat and covers the end surface of the outer lead wire 26. The thickness of the connection portion 75 is 10 μm, which is the same as that of the thin coat portion 76. Such a construction, in which the lead wire 73 does not protrude from the outer surface of the glass bulb 10, makes the lead wire 73 more difficult to bend than the aforementioned corresponding constructions, and makes the sealing portion 12 more difficult to break if a stress is given to the lead wire 73.

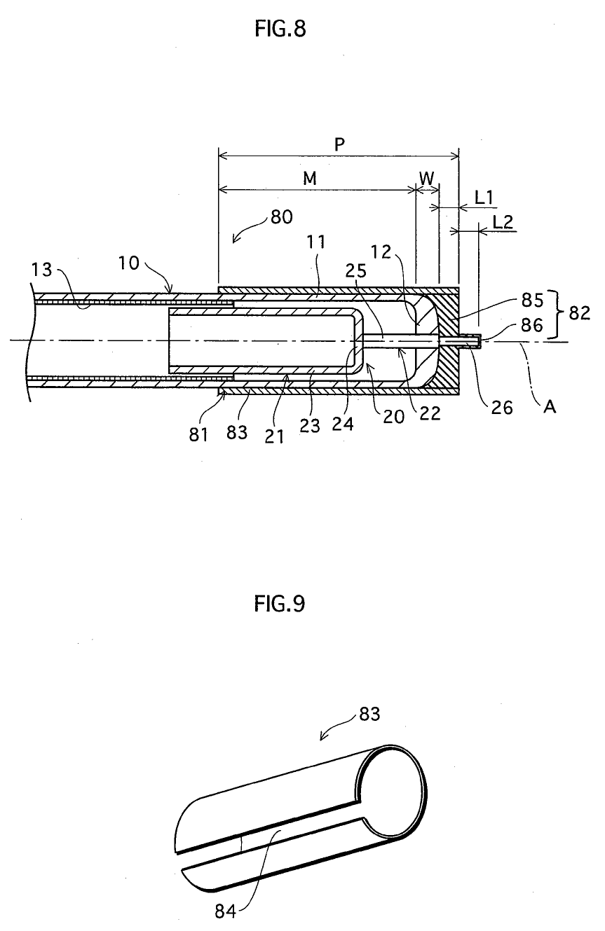

FIG. 8 is an enlarged cross section of an end portion of the cold-cathode fluorescent lamp of Modification 4 of Embodiment 1. FIG. 9 is a perspective view of a thin coat member of the electrically connected terminal. An electrically connected terminal 81 of a cold-cathode fluorescent lamp 80 shown in FIG. 8 is composed of: a connection member 82 made of solder; and a thin coat member 83 made of an iron-nickel alloy. As understood from this, the whole electrically connected terminal 81 may not necessarily be made of the same material.

As shown in FIG. 9, the thin coat member 83 is a cylinder formed in the cross-sectional shape of character C, is 120 μm thick, and is fitted onto an end portion of the glass bulb 10. The inner diameter of the thin coat member 83 is, to a certain degree, smaller than the outer diameter of the glass bulb 10. The thin coat member 83 is also provided with a slit 84. The thin coat member 83 is designed such that the inner surface of the thin coat member 83 is in close contact with the outer surface of the glass bulb 10 if there is, to a certain degree, a measurement error between the inner diameter of the thin coat member 83 and the outer diameter of the glass bulb 10.

The cross-sectional shape of the thin coat member 83 is not limited to character C, but may be, for example, a polygon such as an approximate triangle or an approximate rectangle, or an ellipse. For each shape of the thin coat member 83, a slit may be provided or may not be provided.

It is preferable that the length P in the tube axis A direction of a portion of the glass bulb body 11 that is fitted in the thin coat member 83 is 19 mm or less, depending on the thickness of the thin coat member 83. Furthermore, in the electrode body 21, the light-emitting portion of the lamp is located on the side of the center of the glass bulb body 11, not on the side of the sealing portion 12. Accordingly, when the loss of the lumen due to the thin coat member 83 is taken into consideration, it is more preferable that the length P is 10 mm or less.

The outer lead wire 26 is 2 mm in length, where the length is divided into L1 and L2. The length L1 of a portion of the outer lead wire 26 inside the thin coat member 83 on the inner lead wire 25 side is 1 mm, and the length L2 of the remaining portion protruding from the thin coat member 83 outside is 1 mm. The connection member 82 is composed of a thick area 85 and a thin area 86. The thick area 85 is connected to the portion of the outer lead wire 26 that is inside the thin coat member 83, and the thin area 86 covers the portion of the outer lead wire 26 that is protruding from the thin coat member 83 outside.

In the above-described construction of the electrically connected terminal 81, since the outer lead wire 26 is fixed by the thick area 85 of the connection member 82, If the protruding portion of the outer lead wire 26 is bumped against something, the sealing portion 12 of the glass bulb 10 is difficult to receive a stress, and the sealing portion 12 is difficult to break. However, since it is preferable that the outer lead wire 26 is difficult to bump, it is preferable that the outer lead wire 26 does not protrude from the thin coat member 83 outside, or that the length L2 of the protruding portion is 1 mm or less. Further, as is the case with Modification 3, the outer lead wire 26 may not be provided.

It should be noted here that not applying only to the cold-cathode fluorescent lamp 80 in Modification 4 of Embodiment 1, but in terms of each cold-cathode fluorescent lamp of the present invention, it is preferable that the length of the protruding portion is 1 mm or less since as the protruding portion of the outer lead wire 26 is longer, the protruding portion is bumped against something more easily. The protruding portion of the outer lead wire 26 is, for example, the portion corresponding to the length L2 in the case of Modification 4, and the portion corresponding to the length L3 in the case of Modification 2. That is to say, the protruding portion of the outer lead wire 26 is a portion where the outer surface of the electrically connected terminal protrude drastically by the outer lead wire.

The material of the electrically connected terminal 30 is not limited to solder, but may be any material in so far as it has electrical conductivity. However, it is preferable that the electrically connected terminal 30 is made of a material that has a low thermal conductivity so as not to increase the thermolytic action of the electrically connected terminal 30.

Generally speaking, solder is preferable as the material of the electrically connected terminal 30 since it has high electrical conductivity, has low thermal conductivity, and is low in price. In particular, solder based on tin (Sn), a tin-indium (In) alloy, or a tin-bismuth (Bi) alloy is more preferable since it makes the electrically connected terminal 30 mechanically stronger. Any of these solder to which at least one of stibium (Sb), zinc (Zn), aluminum (Al), gold (Au), silver (Ag), copper (Cu), iron (Fe), platinum (Pt), and palladium (Pd) is added is more preferable since it conforms to glass well and makes the electrically connected terminal 30 difficult to be removed from the glass bulb 10. In addition, solder that does not contain lead is preferable since it makes it possible to manufacture the cold-cathode fluorescent lamp 1 that is friendly to environment.

When the material of the electrically connected terminal 30 conforms to tungsten well, the outer lead wire 26 may be made of tungsten. That is to say, the whole lead wire 22 may be made of tungsten. This construction reduces the breaking of the lead wire 22 and also reduces the cost of the parts.

The above-described cold-cathode fluorescent lamp 1 operates with lighting frequency of 40 kHz to 120 kHz and lamp current of 3.5 mA to 8.5 mA.

Up to now, the cold-cathode fluorescent lamp of the present invention has been described through an embodiment and modifications. However, the cold-cathode fluorescent lamp is not limited to such embodiment and modifications. For example, the cold-cathode fluorescent lamp is not limited to the shape of a straight-tube type, but may be a curved cold-cathode fluorescent lamp that is, for example, in an approximate shape of character U. It should be noted here that in the present application, lamps in the approximate shape of character U includes: a lamp whose portion corresponding to the bottom of the character U is in an approximate shape of arc; and a lamp whose portion corresponding to the bottom of the character U is partially straight.

It is further possible to cover the outer surface of the electrically connected terminal with a material that has electrical conductivity and has low thermal conductivity. For example, the outer surface of the electrically connected terminal made of solder may be covered with a cylindrical member made of tantalum. This makes the electrically connected terminal difficult to remove.

### Embodiment 2

### Cold-Cathode Fluorescent Lamp

The following describes the cold-cathode fluorescent lamp in Embodiment 2, with reference to the drawings.

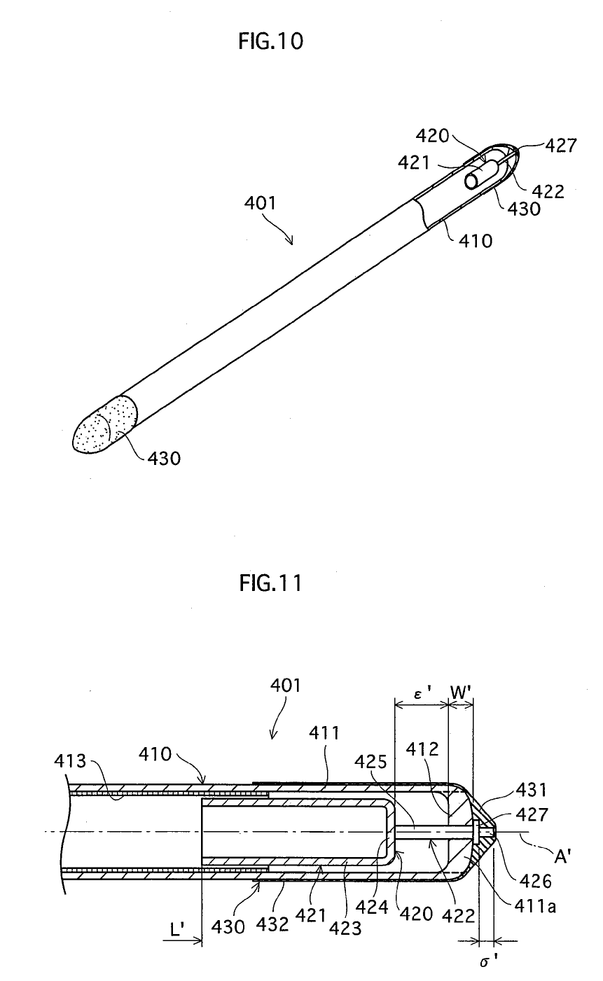

FIG. 10 is a cutaway perspective view showing a cold-cathode fluorescent lamp 401 in Embodiment 2. FIG. 11 is an enlarged cross section showing an end of the cold-cathode fluorescent lamp 401. The cold-cathode fluorescent lamp 401 is used as a light source of a backlight unit, and includes a glass bulb 410, a pair of hollow electrodes 420 that are respectively hermetically connected to the glass bulb 410 at both ends of the glass bulb 410, and electrically connected terminals 430 that are respectively provided on the outer surface of the glass bulb 410 at both ends thereof.

The glass bulb 410 is made from a glass tube that is made of borosilicate glass (SiO₂-α₂O₃—Al₂O₃—K₂O—TiO₂), and is 730 mm in length.

The glass bulb 410 includes a tubular glass bulb body 411, and a pair of sealing portions 412 positioned at both ends in the longitudinal direction of the glass bulb body 411. The sealing portion 412 is made of a glass bead 411a. It should be noted here that the material of the glass bulb 410 is not limited to borosilicate glass, but may be, for example, soda glass. In this case, it is preferable, when the workability of soda glass and improvement in the start-up characteristics in dark surrounding are taken into consideration, that the rate of content of sodium oxide in the soda glass is 3% to 20%. For information, if the rate of content of sodium oxide in the soda glass is 5% or more, the start-up time in dark surrounding is approximately one second or less. Conversely, if the rate of content of sodium oxide in the soda glass is more than 20%, various defects occur: a use of the lamp for long hours causes the glass bulb to become white to reduce the brightness; and the strength of the glass bulb 10 is reduced, for example. When the friendliness to environment is taken into consideration, it is preferable to use soda glass that contains 3% to 20% of alkaline metal and contains 0.1% or less of lead (what is called “lead-free glass”). It is more preferable to use glass that contains 0.01% or less of lead.

The glass bulb body 411 is annular in the cross section, and is 4 mm in outer diameter, 3 mm in inner diameter, and 0.5 mm in thickness. The sealing portion 412 is, as shown in FIG. 11, 2 mm in maximum width W′ in the direction of tube axis A′ of the glass bulb 410. The hollow electrode 420 is hermetically connected to the sealing portion 412.

The glass bulb 410 is not limited to the above-stated construction. However, to make the cold-cathode fluorescent lamp 401 spindly, it is preferable that the glass bulb 410 has a small diameter and a small thickness. In general, it is preferable that the glass bulb body 411 is 1.8 mm to 6.0 mm in outer diameter (1.4 mm to 5.0 mm in inner diameter).

A phosphor layer 413 is formed on the inner surface of the glass bulb 410. The phosphor layer 413 is made of a rare-earth phosphor that is made by mixing: red phosphor (Y₂O₃:Eu); green phosphor (LaPO₄:Ce, Tb); and blue phosphor (BaMg₂Al₁₆O₂₇:Eu, Mn). Further, the inner space of the glass bulb 410 is filled with approximately 1200 μg of mercury and a neon-argon mixture gas (Ne:95%+Ar:5%) of approximately 8 kPa (20° C.) as a rare gas.

It should be noted here that the constructions of the phosphor layer 413, mercury, and rare gas are not limited to the above-described ones. For example, the inner space of the glass bulb 410 may be filled with a neon-krypton mixture gas (Ne:95%+Kr:5%) as a rare gas. Using a neon-krypton mixture gas as a rare gas improves the start-up characteristics of the lamp and enables the cold-cathode fluorescent lamp 401 to be lighted with a low voltage.

The hollow electrode 420 includes: a lead wire 422 that is fixed to the cylindrical glass bead 411a (indicated by dotted lines in FIG. 11) while being inserted in the center hole thereof; and an electrode body 421 that is welded to an end of the lead wire 422. The hollow electrode 420 is hermetically connected to the glass bulb 410 when the glass bead 411a is inserted in the glass bulb 410 to be hermetically connected thereto.

The electrode body 421 is made of nickel (Ni), is in the shape of a cylinder with a bottom, and includes a cylinder portion 423 and a bottom portion 424. The material of the electrode body 421 is not limited to nickel, and the electrode body 421 may be made of, for example, niobium (Nb), tantalum (Ta), or molybdenum (Mo).

The cylinder portion 423 is 5.2 mm length, 2.7 mm in outer diameter, 2.3 mm in inner diameter, and 0.2 mm in thickness. The hollow electrode 420 is arranged such that the tube axis of the cylinder portion 423 substantially matches the tube axis of the glass bulb 410, and such that the distance between the outer circumferential surface of the cylinder portion 423 and the inner surface of the glass bulb 410 is approximately constant all over the outer circumferential surface of the cylinder portion 423.

The distance between the outer circumferential surface of the cylinder portion 423 and the inner surface of the glass bulb 410 is 0.15 mm, as one example. When this distance is as small as 0.15 mm, the discharge does not enter the space between the outer circumferential surface of the cylinder portion 423 and the inner surface of the glass bulb 410, and the discharge occurs only inside the hollow electrode 420. This construction accordingly provides a long life of the cold-cathode fluorescent lamp 401 since it prevents the material sputtered by the discharge from attaching to the inner surface of the glass bulb 410. On the other hand, the discharge does not go around to the lead wire 422 side. This prevents the lead wire 422 from being heated by the discharge.

The distance between the outer circumferential surface of the cylinder portion 423 and the inner surface of the glass bulb 410 is not limited to 0.15 mm, but preferably may be 0.2 mm or less so as to prevent the discharge from entering the space therebetween.

The lead wire 422 is formed by linking by welding an inner lead wire 425 made of tungsten (W), which has approximately the same thermal expansion coefficient as the glass bulb 410, with an outer lead wire 426 that has approximately the same diameter as the inner lead wire 425 and is made of nickel that can easily attach to solder or the like. A block 427, which is larger than the inner lead wire 425 in outer diameter, is provided at a position where the inner lead wire 425 is connected to the outer lead wire 426. The block 427 is formed such that it is in close contact with an end surface of the glass bulb 410 (that is to say, the outer lead wire 426 and the block 427 are outside the end surface of the glass bulb 410). This construction enables the distance between the block 427 and the hollow electrode 420 to be constant. That is to say, it is possible to make a distance ε′ as small as approximately 0.5 mm to elongate an effective light-emission length L′, where the distance ε′ is a distance between the bottom outer surface of the hollow electrode 420 and the inner surface of the glass bulb 410 at each end of the glass bulb 410. This construction also enables a force, that is applied to the block 427 when the projecting portion of the outer lead wire 426 is bumped against something outside, to be absorbed by the end of the glass bulb 410. Accordingly, this construction prevents the sealing portions 412 of the glass bulb 410 in which the inner lead wire 425 from being broken, thus preventing leakage of the inner contents. The block 427 is made of nickel, which is also the material of the outer lead wire 426. However, the material of the block 427 is not limited to nickel, but may be, for example, a Fe—Ni alloy, a Cu—Ni alloy, or the material of DUMET.

The inner lead wire 425 is approximately circular in the cross section, and is 3 mm in length and 0.8 mm in diameter. An end of the inner lead wire 425 on the block 427 side is hermetically connected to the sealing portion 412 of the glass bulb 410, and the other end thereof opposite to the outer lead wire 426 is connected to the bottom portion 424 of the electrode body 421 at approximately the center of the outer surface thereof.

The outer lead wire 426 and the block 427 protrude from the outer surface of the glass bulb 410 in the tube axis A′ direction, and are connected to the electrically connected terminal 430. The outer lead wire 426 and the block 427 are approximately circular in the cross section. A length σ′ of the outer lead wire 426, including the length of the block 427, is 1 mm. The outer lead wire 426 and the block 427 are arranged such that the axis of the lead wire 426 substantially matches the tube axis A′ of the glass bulb 410.

It is preferable that the length σ′ of the outer lead wire 426, including the length of the block 427, is 1 mm or less. It is preferable that the outer diameter of the block 427 is 1.5 times to 4 times the outer diameter of the inner lead wire 425 when the damage to the sealing portion 412 and the cost of the parts are taken in to consideration. As described earlier, to make the cold-cathode fluorescent lamp 401 spindly, it is preferable that the glass bulb body 411 is 1.8 mm to 6.0 mm in outer diameter. If the length σ′ of the outer lead wire 426, including the length of the block 427, is 1 mm or less in the tube axis A′ direction in the cold-cathode fluorescent lamp 401 of this size, the outer lead wire 426 is not an excessive protrusion for the cold-cathode fluorescent lamp 401 as a whole. The outer lead wire 426 of this size has resistance to bending, damage and the like which may occur when it is bumped against something. For example, the outer lead wire 426 of this size is difficult to bend if it is bumped against the backlight unit 100 when the cold-cathode fluorescent lamp 401 is attached to the backlight unit 100. And the sealing portion 412 is difficult to break if a stress is given to the outer lead wire 426 when the outer lead wire 426 is bumped against the backlight unit 100.

The electrically connected terminals 430 are respectively provided at opposite ends of the glass bulb 410 to cover the end portions. The electrically connected terminal 430 is made of solder, and is composed of: a connection portion 431 that is connected to the outer lead wire 426 and the block 427; and a thin coat portion 432 being the remaining portion.

That is to say, the electrically connected terminal 430 is electrically connected to the inner lead wire 425 at the connection portion 431. The connection portion 431 has an approximate appearance of circular cone. For this reason, the area of the outer surface of the connection portion 431 is small even though it entirely covers the outer surface of the outer lead wire 426. The area of the outer surface of the electrically connected terminal 430 is also small, and the thermolytic action is small. As a result, the temperature of the inner lead wire 425 is difficult to decrease. Also, since the outer surface of the outer lead wire 426 is entirely covered with the electrically connected terminal 430, the outer lead wire 426 is difficult to bend, and the sealing portion 412 is difficult to break if a stress is given to the outer lead wire 426. It is preferable that the area of the outer surface of the connection portion 431 is as small as possible.

The thin coat portion 432 is formed in a predetermined area on the outer surface of the glass bulb body 411 on the sealing portion 412 side, and is formed in a predetermined area on the outer surface of the sealing portion 412 on the glass bulb body 411 side. To suppress the thermolytic action of the electrically connected terminal 430, it is preferable that the area in which the thin coat portion 432 is formed is as small as possible.

The electrically connected terminal 430 may be formed by a known dipping method (refer to, for example, Japanese Laid-Open Patent Application No. 2004-146351). Here, how the electrically connected terminal 430 is formed by the dipping method will be briefly explained. For example, the electrically connected terminal 430 can be formed by soaking the sealing portion 412 of the glass bulb 410, to which the hollow electrode 420 is hermetically connected, into solder fusion in a melting tank. Ultrasonic wave may be added when the sealing portion 412 is soaked into the solder fusion. Such dipping method enables the electrically connected terminal 430 to be easily and less expensively formed, contributing to reduction in the manufacturing cost of the cold-cathode fluorescent lamp 401.

The electrically connected terminal 430 may be formed by a method other than the dipping method. For example, the electrically connected terminal 430 may be formed by the vapor deposition method or by the plating.

The construction of the electrically connected terminal 430 is not limited to the above-described one, but may be, for example, any of the constructions of the Modifications 1 to 3 shown below. Basically, the cold-cathode fluorescent lamp of the Modifications 1 to 3 has the same construction as the cold-cathode fluorescent lamp 401 of Embodiment 2 except for the construction of the electrically connected terminals and electrodes. The following description therefore focuses on the differences from Embodiment 2, and the common elements are assigned the same reference signs as in Embodiment 21 and description thereof is omitted.

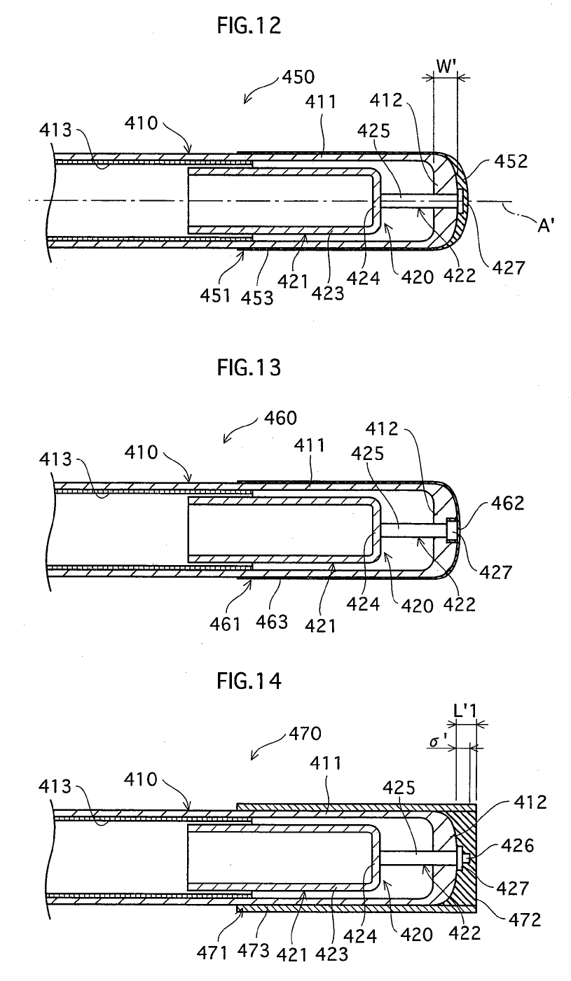

FIG. 12 is an enlarged cross section of an end portion of the cold-cathode fluorescent lamp of Modification 1 of Embodiment 2. An electrically connected terminal 451 of a cold-cathode fluorescent lamp 450 shown in FIG. 12 is composed of a connection portion 452 and a thin coat portion 453. The lead wire 422 is formed by, for example, welding a block 427 made of nickel to an end surface of the inner lead wire 425 made of tungsten. The connection portion 452 has an approximate appearance of hemisphere, and entirely covers the outer surface of the block 427 of the lead wire 422.

Since the block 427 is entirely covered with the electrically connected terminal 452, and the end of the cold-cathode fluorescent lamp 450 is smoothly rounded by the electrically connected terminal 452, the block 427 is difficult to bend, and the sealing portion 412 is difficult to break if the end of the cold-cathode fluorescent lamp 450 is bumped against something.

The material of the block 427 is not limited to nickel. For example, the block 427 may be formed by first forming a prototype of the block 427 using tungsten, which is also the material of the inner lead wire 425, then plating part or all of the surface of the prototype with nickel that can easily attach to solder or the like.

FIG. 13 is an enlarged cross section of an end portion of the cold-cathode fluorescent lamp of Modification 2 of Embodiment 2. An electrically connected terminal 461 of a cold-cathode fluorescent lamp 460 shown in FIG. 13 is composed of a connection portion 462 and a thin coat portion 463. The lead wire 422 is formed by, for example, welding a block 427 made of nickel to an end surface of the inner lead wire 425 made of tungsten. The block 427 is embedded in an end of the glass bulb 410. The connection portion 462 covers the outer surface of the block 427 of the lead wire 422. Both of the connection portion 462 and the thin coat portion 463 are 10 μm in thickness.

With the above-stated construction, since the block 427 is embedded in an end of the glass bulb 410, the block 427 does not bump against something outside and the sealing portion 412 is protected from damage. Also, such a construction, in which the entire electrically connected terminal 461 is a thin coat, reduces the use amount of solder, contributing to reduction in the manufacturing cost of the cold-cathode fluorescent lamp 460.

In particular, when the entire electrically connected terminal 461 is made of solder, the aforementioned dipping method is convenient for forming the electrically connected terminal 461. As a result, compared with a conventional electrically connected terminal which is assembled from parts, the electrically connected terminal of the present modification makes it possible to manufacture the cold-cathode fluorescent lamp 460 easily and at low cost. In addition, generally, solder has lower thermal conductivity than the iron-nickel alloy, which is typically used for the electrically connected terminal 461 when it has the shape of a cap. Therefore, when it is made of solder, the electrically connected terminal 461 reduces the thermolytic action. This prevents decrease of the lamp brightness.

In Modification 2 of Embodiment 2, the block 427 is entirely embedded in the end of the glass bulb 410. However, not limited to this, part of the block 427 may be embedded in the end of the glass bulb 410. Here, as the amount of the block 427 that is embedded in the end of the glass bulb 410 increases, the probability of the block 427 bumping against something outside decreases.

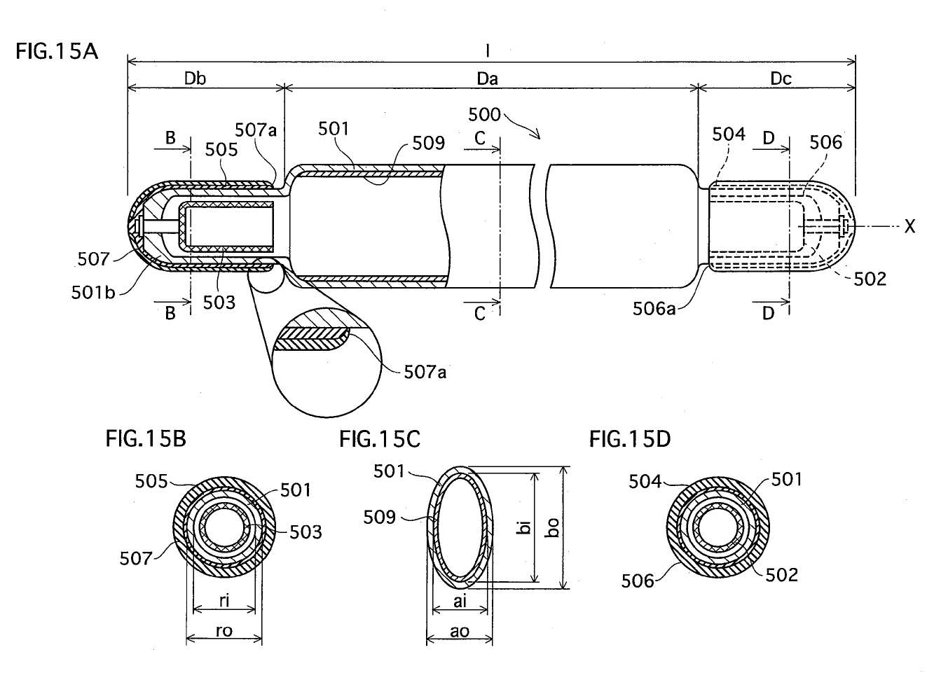

FIG. 14 is an enlarged cross section of an end portion of the cold-cathode fluorescent lamp of Modification 3 of Embodiment 2. An electrically connected terminal 471 of a cold-cathode fluorescent lamp 470 shown in FIG. 14 is composed of: a connection member 472 made of solder; and a thin coat member 473 made of an iron-nickel alloy. As understood from this, the whole electrically connected terminal 471 may not necessarily be made of the same material. The thin coat member 473 has the same construction as the thin coat member 83 shown in FIG. 9.

The length σ′ of the outer lead wire 426, including the length of the block 427, is 1 mm. A length L′1 of the connection member 472, in the tube axis direction of the lamp, that contains the outer lead wire 426 and the block 427, is 1.5 mm. The length L′1 is equivalent to the thickness of the connection member 472.

With the above-stated construction of the electrically connected terminal 471, since the outer surface of the outer lead wire 426 does not protrude from the end surface of the cold-cathode fluorescent lamp 470, if the electrically connected terminal 471 is bumped against something outside, a stress is not applied to the sealing portion 412 and the sealing portion 412 is difficult to break.

The material of the electrically connected terminals 430, 451, and 461 is not limited to solder, but may be any material in so far as it has electrical conductivity. However, it is preferable that the electrically connected terminals 430, 451, and 461 are made of a material that has a low thermal conductivity so as not to increase the thermolytic action of the electrically connected terminals 430, 451, and 461.

Generally speaking, solder is preferable as the material of the electrically connected terminals 430, 451, and 461 since it has high electrical conductivity, has low thermal conductivity, and is low in price. In particular, solder based on tin (Sn), a tin-indium (In) alloy, or a tin-bismuth (Bi) alloy is more preferable since it makes the electrically connected terminal 430 mechanically stronger. Any of these solder to which at least one of stibium (Sb), zinc (Zn), aluminum (Al), gold (Au), silver (Ag), copper (Cu), iron (Fe), platinum (Pt), and palladium (Pd) is added is more preferable since it conforms to glass well and makes the electrically connected terminals 430, 451, and 461 difficult to be removed from the glass bulb 410. In addition, solder that does not contain lead is preferable since it makes it possible to manufacture the cold-cathode fluorescent lamp 401 that is friendly to environment.

The above-described cold-cathode fluorescent lamp 401 operates with lighting frequency of 40 kHz to 120 kHz and lamp current of 3.5 mA to 8.5 mA.

Up to now, the cold-cathode fluorescent lamp of Embodiment 2 has been described through an embodiment and modifications. However, the cold-cathode fluorescent lamp is not limited to such embodiment and modifications. For example, the cold-cathode fluorescent lamp is not limited to the shape of a straight-tube type, but may be a curved cold-cathode fluorescent lamp that is, for example, in the approximate shape of character U.

It is further possible to cover the outer surface of the electrically connected terminal with a material that has electrical conductivity and has low thermal conductivity. For example, the outer surface of the electrically connected terminal made of solder may be covered with a thin coat member made of tantalum, as shown in FIG. 9. This makes the electrically connected terminal difficult to remove.

### Embodiment 3

### Cold-Cathode Fluorescent Lamp

The shape of the cold-cathode fluorescent lamp in the cross section is not limited to a circle, but may be, for example, an ellipse or an elongate-hole circle. Such a cold-cathode fluorescent lamp is referred to as a flattened cold-cathode fluorescent lamp. For example, FIGS. 15A to 15D show a cold-cathode fluorescent lamp 500 which includes a glass bulb 501 on whose inner surface, a phosphor layer 509 is formed. In the glass bulb 501, a light extraction portion (a portion between the center-side ends of the hollow electrodes 502 and 503 respectively disposed at both ends of the glass bulb 501), within a positive column light emitting portion (an area in which the positive column is substantially generated), is in a flattened shape in a cross section, and end portions of the glass bulb 501, at least such portions that correspond to the hollow electrodes 502 and 503, are in a shape of a circle, where a length Da of the flattened light extraction portion in the tube axis X direction is larger than lengths Db and Dc of the circular end portions of the glass bulb 501 respectively corresponding to the hollow electrodes 503 and 502.

Measurement of the lamp 500 is as follows. An overall length I of the lamp 500 is 705 mm. The length Da of the positive column light emitting portion is approximately 680 mm. Lengths Db and Dc of the electrode portions, which are in the shape of a circle in the cross section, are approximately 12 mm, respectively. An outer surface area of the positive column light emitting portion is approximately 105 cm². A minimum outer diameter ao of the approximate ellipse is 4.0 mm. A minimum inner diameter ai of the approximate ellipse is 3.0 mm. A maximum outer diameter bo of the approximate ellipse is 5.8 mm. A maximum inner diameter bi of the approximate ellipse is 4.8 mm. Also, an outer diameter ro of the approximate circle is 5.0 mm, and an inner diameter ri of the approximate circle is 4.0 mm.

With the stated construction in which the light extraction portion of the glass bulb 501 is flattened in the cross section, it is possible to suppress an excessive increase of the coldest-part temperature by causing the lamp to have a larger outer surface area than conventional straight-tube lamps. Also, since the minimum inner diameter ai of the approximate ellipse is shorter than the maximum inner diameter bi that is equal to the inner tube diameter of the conventional straight-tube lamps, it is possible to maintain the distance between the center of the positive column plasma space and the tube inner wall to be effectively short. This makes it possible to have a larger lamp current than the conventional lamps, and at the same time makes the light emission efficiency difficult to decrease.

The electrically connected terminal is not limited to the constructions shown in Embodiments 1 and 2. For example, the electrically connected terminal may be constructed, as shown in FIGS. 15A to 15D, to include: body layers 504 and 505 that are formed on the outer surface of the glass bulb 501 and the major component thereof is silver or copper; and coating layers 506 and 507 that are formed on the outer surface of the body layers 504 and 505 respectively and the major component thereof is solder. With this construction, the body layers 504 and 505 of the electrically connected terminal are difficult to be exposed to the atmospheric air, and sulphurization of silver or oxidization of copper is difficult to occur, and thus reduction of conductivity is difficult to occur. As a result, it is possible to make the connectability between the electrically connected terminal and the lead wire of the electrode excellent. Also, it makes the electrically connected terminal resistant to flaws or cracks when the cold-cathode fluorescent lamp is installed in a lamp holder.

In Embodiment 3, the maximum thickness of the electrically connected terminal is 5 μm to 120 μm. And the thickness of the end portions 506a and 507a of the electrically connected terminal becomes smaller as they are closer to the ends, respectively. This construction, compared with the construction where the end portions of the electrically connected terminal are square, prevents the corona discharge that occurs in a space between the end portions of the electrically connected terminal and outer surface of the glass bulb 501, and thus prevents generation of ozone. It should be noted here that if the thickness of the electrically connected terminal is smaller than 5 μm, removability of the thin coat from the body layers 504 and 505 reaches to an extent of uselessness in the practical use.

On the other hand, if the thickness of the electrically connected terminal is larger than 120 μm, the outer surface area of the electrically connected terminal becomes excessively large and the thermolytic action of the electrically connected terminal becomes excessively large. When this happens, the temperature of the lead wire of the electrode is apt to be lower than that of the conventional cold-cathode fluorescent lamps. And when this happens, a sufficient lamp brightness may not be obtained.

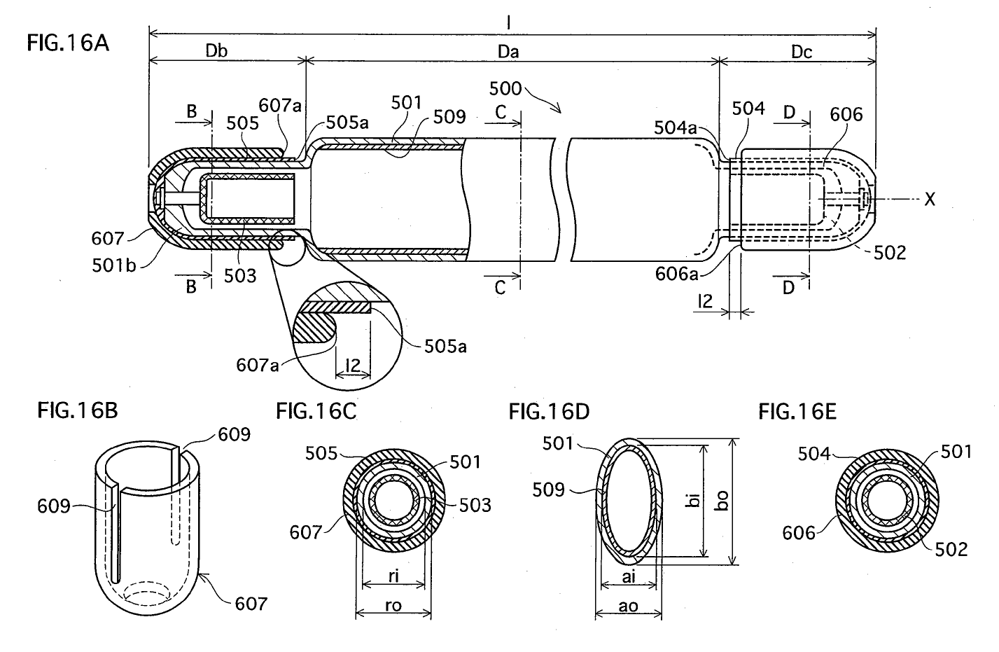

As the outer layer, the coating layers 506 and 507 may be replaced with metal members 606 and 607 that are in the shape of a cap and are connected to surround at least part of the outer surface of the body layers 504 and 505, as shown in FIGS. 16A to 16E. The metal member 606 has the same construction as the metal member 607. The metal member 607 has an excellent electric conductivity, and its thermal expansion coefficient is close to that of the glass bulb 501. The metal member 607 is made of, for example, Fe—Ni—Co (kovar), and is formed in the shape of an end of a cylinder covered with a semispherical dome. The metal member 607 is constructed to have an elastic force, which is achieved by, for example, two slits 609 that extend in the longitudinal direction. The metal member 607 is attached from an end 501b of the glass bulb 501, and is connected to the body layer 505 by the elastic force of the slits 609. In the present embodiment, the end of the electrically connected terminal is constructed such that, for example, the ends 606a and 607a of the metal members 606 and 607 on the side of the center of the glass bulb 501 are disposed with a distance 12 away from the ends 504a and 505a of the body layers 504 and 505 on the side of the center of the glass bulb 501, towards the end 501b of the glass bulb. With this construction, it is possible, when the lamp is lighted, to prevent a corona discharge from occurring between the metal members 606, 607 and the glass bulb 501, decreasing the amount of generated ozone. It should be noted here that the shape of the metal members 606 and 607 is not limited to a cap, but may be a sleeve.

The cold-cathode fluorescent lamp of the present invention may be any combination of constructions of the cold-cathode fluorescent lamps described above in Embodiments 1 to 3.

### Experiment Results

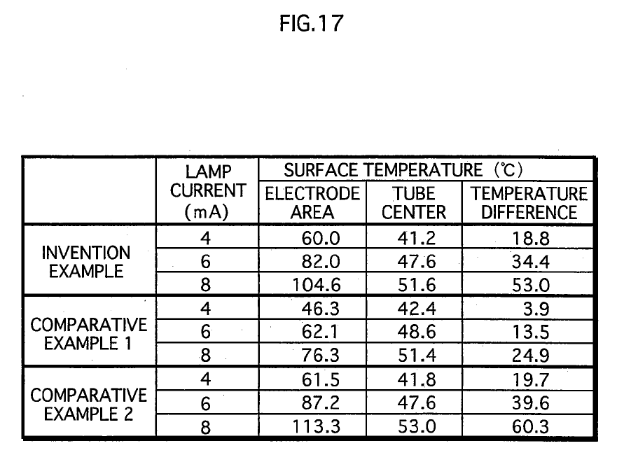

The temperature characteristics of the cold-cathode fluorescent lamp were measured and the thermolytic action of the electrically connected terminal was studied. FIG. 17 shows the temperature characteristics of the cold-cathode fluorescent lamp.

In FIG. 17, the “invention example” indicates a cold-cathode fluorescent lamp of the present invention, and has the same construction as the cold-cathode fluorescent lamp 1 in Embodiment 1 except that the thin coat portion 32 of the electrically connected terminal 30 is 50 μm thick, and that the length N of the electrically connected terminal 30 in the tube axis direction A, as shown in FIG. 4, is 7.5 mm.

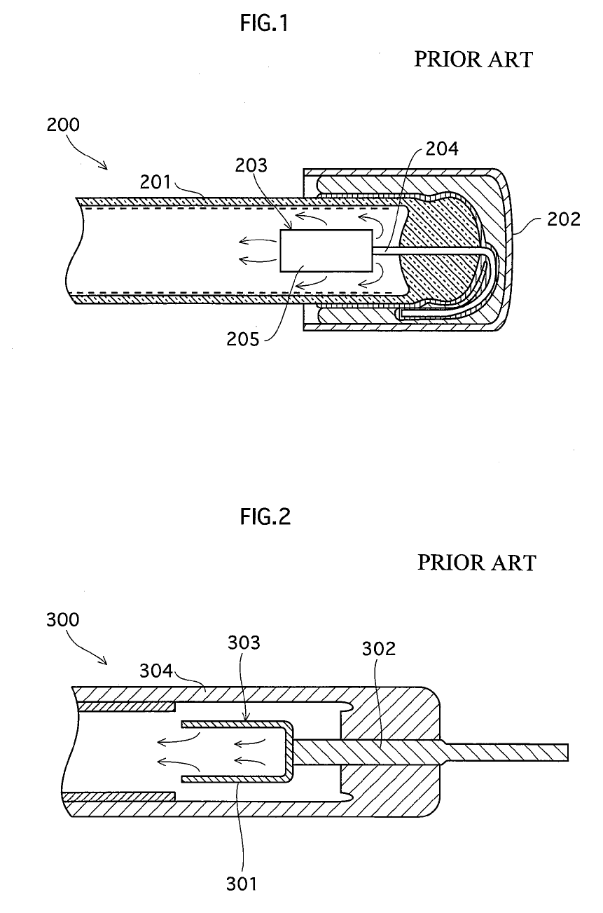

The “comparative example 1” indicates a cold-cathode fluorescent lamp that has the same construction as the cold-cathode fluorescent lamp shown in FIG. 1 for the most part and the electrically connected terminals thereof are in the shape of a cap. The construction of the electrically connected terminals of the “comparative example 1” is however different from that of the cold-cathode fluorescent lamp shown in FIG. 1. More specifically, the lead wire does not protrude from the thin coat member outside, the thin coat member is 150 μm thick, and the length P of the thin coat member in the tube axis A direction of the glass bulb is 7.5 mm. The materials used therein are the same as those of Modification 4.

The “comparative example 2” indicates a cold-cathode fluorescent lamp which does not have the electrically connected terminals as shown in FIG. 2, and it has the same construction as the cold-cathode fluorescent lamp 1 in Embodiment 1 except that the construction of the electrodes and the electrically connected terminals is different from the lamp of the embodiment.

In the experiments, the surface temperature at the center of the glass bulb in the tube axis direction and the surface temperature at areas near the electrodes of the glass bulb were measured, for each of the above-mentioned cold-cathode fluorescent lamps.

As shown in FIG. 17, the cold-cathode fluorescent lamp of the invention example is higher than the cold-cathode fluorescent lamp of the comparative example 1 in the surface temperature at areas near the electrodes. This indicates that a smaller amount of mercury vapor gathers around the electrodes in the cold-cathode fluorescent lamp of the invention example than in the cold-cathode fluorescent lamp of the comparative example 1, causing a more amount of mercury vapor to gather in the discharge path, and providing higher lamp brightness. This is because the electrically connected terminals of the invention example have smaller thermolytic action.

On the other hand, the cold-cathode fluorescent lamp of the invention example and the cold-cathode fluorescent lamp of the comparative example 2 have almost the same surface temperature at areas near the electrodes. Accordingly, almost the same amount of mercury vapor gathers around the electrodes and the discharge path, and almost the same lamp brightness is provided by these cold-cathode fluorescent lamps. It is considered that this is because both lamps have almost the same thermolytic action. The results indicate that if the thickness of the thin coat portion of the electrically connected terminal is 50 μm or less, the same level of lamp brightness as that of a cold-cathode fluorescent lamp that does not have the electrically connected terminals can be obtained.

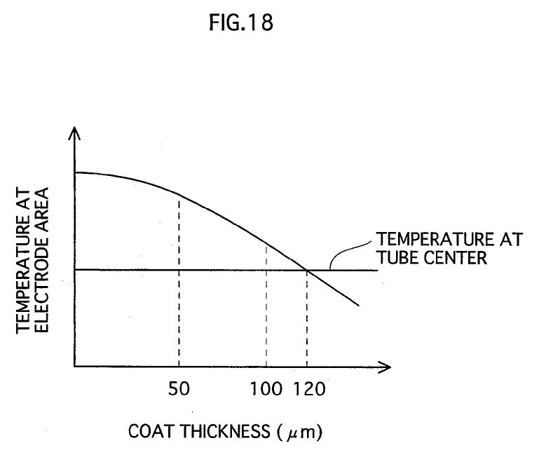

FIG. 18 shows the relationship between the thickness of the thin coat portion of the electrically connected terminal and the temperature near the electrode. As shown in FIG. 18, when the thickness of the thin coat portion 32 of the electrically connected terminal 30 is 120 μm, there is no temperature difference between the area near the electrode 20 and the tube center. Therefore, to prevent the temperature at the area near the electrode 20 from becoming lower than the temperature at the tube center, it is preferable that the thickness of the thin coat portion 32 is 120 μm or less. In the present invention, the thin coat is defined as a coat that is 120 μm or less in thickness.

### <Backlight Unit and Lighting Apparatus>

### Embodiment 1

### Backlight Unit

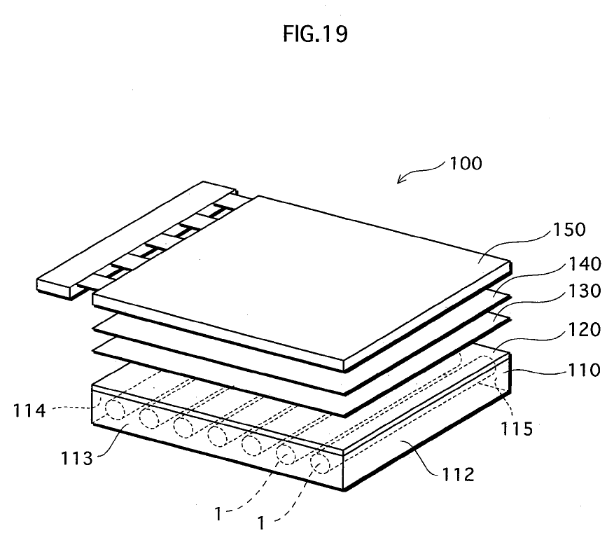

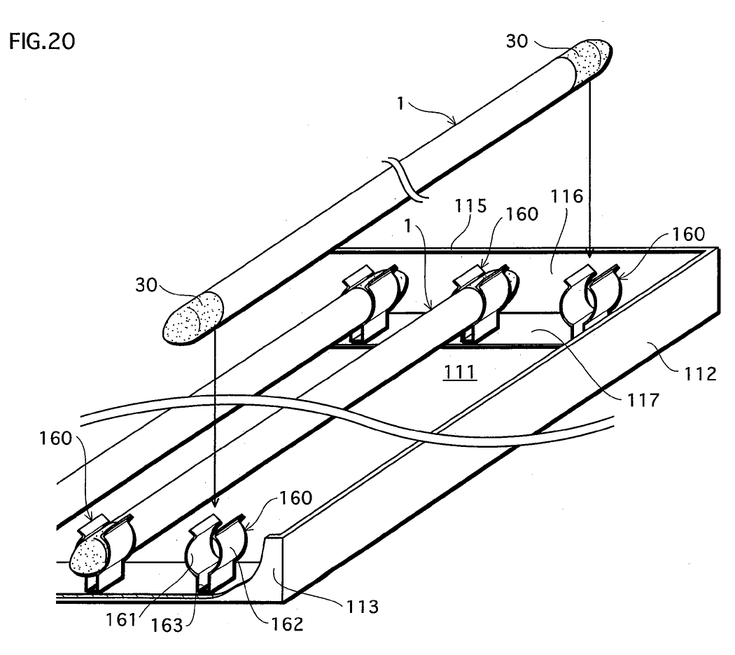

FIG. 19 is an exploded perspective view showing an outline construction of the backlight unit and the like in Embodiment 1 of the present invention. FIG. 20 shows how the cold-cathode fluorescent lamp is attached.

As shown in FIG. 19, a backlight unit 100 in Embodiment 1 of the present invention is a direct-below type for a liquid crystal display apparatus, and its construction is basically the same as that of a conventional backlight unit.

The backlight unit 100 includes: an outer container 110; a diffusion plate 120; a diffusion sheet 130; and a lens sheet 140, and is arranged at the back of a liquid crystal panel 150 for use.

The outer container 110 is a box made of white polyethylene terephthalate (PET) resin. As shown in FIG. 20, the outer container 110 is composed of: a reflection plate 111 that is in an approximate shape of a rectangle; and side plates 112-115 that stand along the edges of the reflection plate 111. A plurality of cold-cathode fluorescent lamps 1 are arranged in the outer container 110, and light emitted from the cold-cathode fluorescent lamps 1 goes out through an opening 116 of the outer container 110 toward the diffusion plate 120.

A plurality of lamp holders 160 are attached to the reflection plate 111 such that each cold-cathode fluorescent lamp 1 is held by a pair of lamp holders 160. Each lamp holder 160 is formed by bending a plate made of, for example, stainless, aluminum, or a copper base alloy such as phosphor bronze, and is composed of: a pair of holding pieces 161 and 162; and a linking piece 163 that links the holding pieces 161 and 162 at the lower edges thereof. The pair of holding pieces 161 and 162 are shaped to be concave sideways to form a space that fits the contour of the cold-cathode fluorescent lamp 1. With this construction, when the cold-cathode fluorescent lamp 1 is fitted in the space between the pair of holding pieces 161 and 162, the cold-cathode fluorescent lamp 1 is held by the lamp holder 160 by the elastic force of the pair of holding pieces 161 and 162 as springs, and at the same time, the lamp holder 160 is electrically connected to the electrically connected terminal 30. To the cold-cathode fluorescent lamp 1 attached to the backlight unit 100, power is supplied from an electric ballast (not illustrated) of the backlight unit 100 via the lamp holder 160.

An insulating plate 117 made of polycarbonate is provided between the lamp holders 160 and the outer container 110 to insulate the lamp holders 160 and the outer container 110.

The diffusion plate 120 is a plate made of polycarbonate (PC) resin, and is disposed to cover the opening 116 of the outer container 110. The diffusion sheet 130 is made of polycarbonate resin. The lens sheet 140 is made of acrylic resin. The diffusion sheet 130 and the lens sheet 140 are laid over the diffusion plate 120 one by one.

Up to now, the backlight unit of the present invention has been explained through an embodiment. However, the backlight unit of the present invention is not limited to this, but may be, for example, a backlight unit of an edge-light type (also referred to as a side-light type or a light-guide-panel type) in which a light guide panel is disposed at the back of a liquid crystal panel, and the cold-cathode fluorescent lamp 1 is disposed at the edge of the light guide panel.

### Embodiment 2

### Backlight Unit and Lighting Apparatus

A backlight unit of a direct-below type that includes a plurality of lamps in an approximate shape of character U as a light source is used, for example, in a liquid crystal display (LCD) apparatus. Cold-cathode fluorescent lamps in an approximate shape of character U are also used in the backlight unit. The reason is that the number of lamps can be reduced to one seconds the number of lamps in the case where the straight-tube type cold-cathode fluorescent lamps are used.

In a typical backlight unit, a plurality of cold-cathode fluorescent lamps in the approximate shape of character U are arranged in parallel in the outer container such that the ends of the lamps are aligned on either the right side or the left side. A high voltage of several kV is applied from the lighting apparatus to the electrode lead wires at both ends of each lamp. However, when the ends of the lamps are aligned on one side, the electrodes as heat generating sources gather on the same side, as well. This causes a temperature difference between the right side and the left side of the outer container. The temperature difference affects the mercury vapor pressure of the lamp, and makes the brightness of the backlight unit uneven.

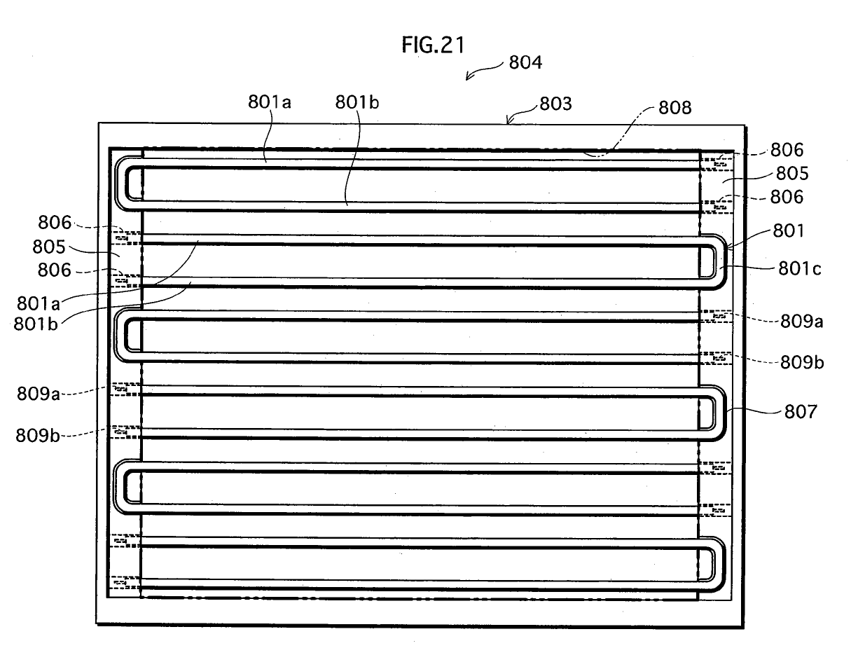

As a technology for addressing the problem, there has been known a backlight unit 804 that is difficult to generate uneven brightness due to a construction in which, as shown in FIG. 21, a plurality of cold-cathode fluorescent lamps 801 (hereinafter referred to merely as lamps 801) in the approximate shape of character U are arranged in parallel in the outer container such that the ends of the lamps are alternately positioned on the right side and the left side (Japanese Laid-Open Patent Application No. 2004-327328).

In the outer container 803 of the backlight unit 804, rubber-made holders 805 are disposed on the right and left sides. The lamps 801 are attached such that the ends 801a and 801b of the lamps 801 are inserted into holes 806 of the holders 805, and bending portions 801c of the lamps 801 are fitted in slits 807 of the holders 805.

However, the above-described backlight unit 804 has a problem that it generates an uneven brightness between the right side and the left side of the outer container 803 since the amount of light emitted from the bending portions 801c is larger than the amount of light emitted from the ends 801a and 801b of the lamps 801.

Although using the lamps 1 in the approximate shape of character U reduces the number of lamps to one seconds the number of lamps in the case where the straight-tube type cold-cathode fluorescent lamps are used, it has a problem that since the lamp length is increased to twice or more, the phosphor coating, in particular, at end portions of the lamp 1 at one end in the longitudinal direction of the lamp (that is to say, the ends of the lamp on the side where the phosphor liquid is suctioned in the phosphor application process) is extremely thinner than the other portions, which is caused during manufacturing. This generates an uneven brightness between the two ends of the lamp in the longitudinal direction of the lamp.

Further, in the lamp 1 in the approximate shape of character U, a high-voltage of several kV is applied to between the electrode lead wires 809a and 809b at the ends 801a and 801b in a same pair. As a result, the electrode lead wires 809a and 809b are connected, by solder or the like, to an end (not illustrated) of a lead wire connected to the lighting apparatus, and the electrode lead wires 809a and 809b are covered with rubber-made holders 805 being insulators. This construction makes it difficult to attach or detach the lamp 801 to/from the holder 805. This construction also has a problem that when attaching the lamp 801 to the outer container 803, the projecting portions of the electrode lead wires 809a and 809b may be bumped against the holders 805 or the like of the box, which applies loads onto portions of the glass bulb to which the electrode lead wires 809a and 809b are hermetically connected, and onto the bending portions 801c of the lamps 801, and breaking the portions onto which the loads are applied, causing a leakage of the inner contents.

The above-stated problems taken into consideration, the backlight unit and the lighting apparatus in Embodiment 2 are aimed to reduce the number of lamps as is the case with the cold-cathode fluorescent lamps in an approximate shape of character U, to reduce the unevenness in brightness in the longitudinal direction of the lamp (between the right side and the left side of the outer container), to prevent the breakage of the sealing portions or the like of the cold-cathode fluorescent lamps, and to enable the cold-cathode fluorescent lamps to be attached or detached to/from easily with a single touch.

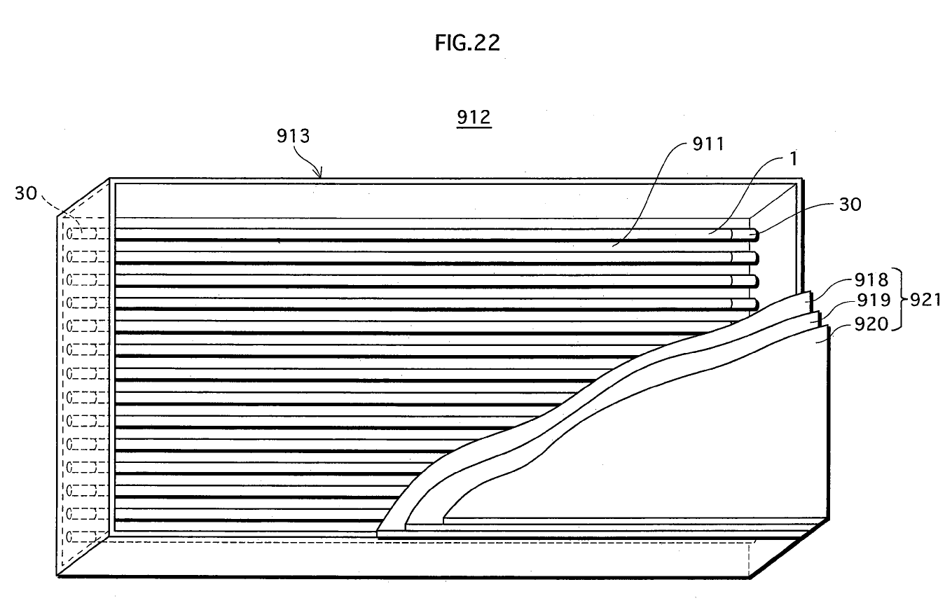

FIG. 22 is a perspective view of a backlight unit 912 in Embodiment 2, where part of a front panel 921 is cut away to show the inner structure.

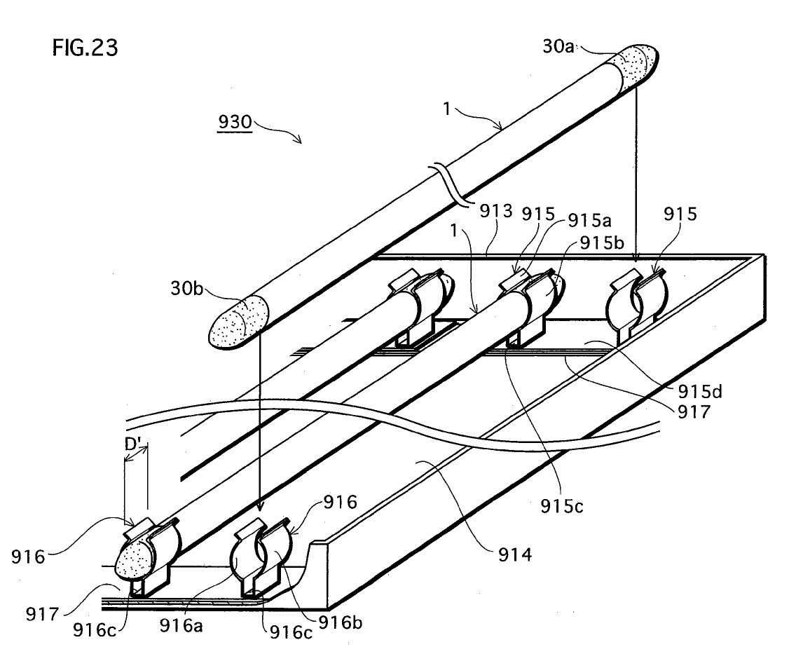

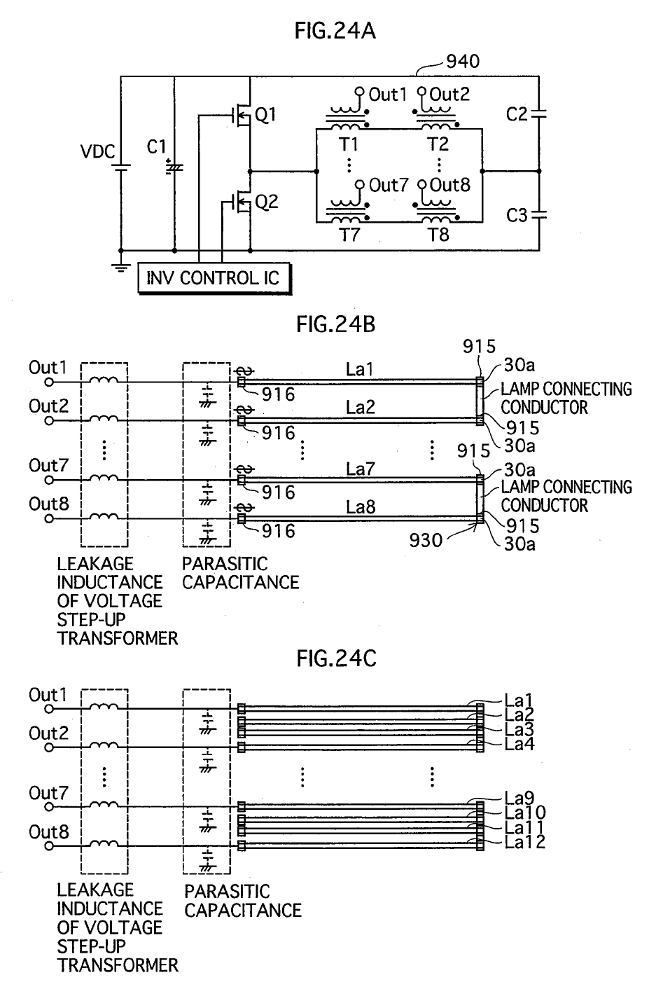

The backlight unit 912 includes, for example: a plurality of cold-cathode fluorescent lamps 1 (hereinafter referred to merely as “lamps 1”); a box 913 that has an opening and houses the lamps 1 therein; a front panel 921 for covering the opening of the box 913; and a lighting apparatus 930 for lighting the plurality of lamps 1 (see FIGS. 23 and 24B).

The box 913 is made of, for example, polyethylene terephthalate (PET) resin. A reflection plane is formed on an inner surface 914 of the box 913 by depositing a metal such as aluminum on the inner surface 914.

Each of the lamps 1 is in a shape of a straight tube and has electrically connected terminals 30a and 30b at both ends thereof. As a whole, 16 lamps 1 are arranged in the box 913 conforming to the direct-below system.

The lighting apparatus 930 is, as shown in FIGS. 23 and 24B, composed of: lamp holders 915 and 916 in an approximate shape of character U that are attached to the inner surface of the box 913 such that each lamp 1 is held by a pair of lamp holders 915 and 916; and an electric ballast 940 (see FIG. 24A) as an electric ballast for lighting each lamp 1 connected to each pair of the lamp holders 915 and 916.

The lamp holders 915 and 916 are electrically conductive, and each of the lamp holders 915 and 916 is formed by, for example, bending a plate made of, for example, stainless, aluminum, or a copper base alloy such as phosphor bronze. Each of the lamp holders 915 and 916 is composed of: holding plates 915a and 915b (916a and 916b); and a linking piece 915c (916c) that links the holding plates 915a and 915b (916a and 916b) at the lower edges thereof. The holding plates 915a and 915b (916a and 916b) are shaped to be concave sideways to form a space that fits the contour of the electrically connected terminals 30a and 30b of the lamp 1. With this construction, when the lamp 1 is fitted in the space between the holding plates 915a and 915b (916a and 916b), the lamp 1 is held by the lamp holder 915 (916) by the elastic force of the holding plates 915a and 915b (916a and 916b) as springs, and at the same time, the lamp holders 915 and 916 are electrically connected to the electrically connected terminals 30a and 30b, respectively. It should be noted here that to prevent a corona discharge from occurring during the lamp lighting, the width D′ of the holding portions of the lamp holders 915 and 916 is designed so that the holding portions are within the electrically connected terminals 30a and 30b, which are provided at both ends of the lamp 1, in terms of the length in the tube axis direction of the lamp 1.

To each lamp 1 attached to the backlight unit 912, power is supplied from the electric ballast 940 shown in FIG. 24A via the lamp holders 915 and 916.

Here, the plurality of lamps 1 are arranged substantially in parallel at regular intervals such that each of the lamps 1 is held by a pair of lamp holders 915 and 916, and such that lamp holders 915 holding electrically connected terminals 30a of two adjacent lamps 1 (in FIG. 24B, electrically connected terminals 30a of lamps La1, La2, La7, La8 and so on) are connected to each other. With this construction, it is possible to form a pseudo-curved tube (tube in the approximate shape of character U) using, for example, lamps La1 and La2 that are adjacent to each other. As a result, with this construction, it is possible to form a pseudo-curved tube (tube in the approximate shape of character U) and reduce the number of inverters to half of before, to reduce, compared with conventional lamps having curved portions, the unevenness of brightness between the right side and the left side of the box in the longitudinal direction of the lamp, to prevent the sealing portion or the like of the lamp 1 from breaking, and to attach or detach the lamp 1 easily with a single touch. Also, with this construction in which the lamps 1 in the shape of straight tubes having electrodes at both ends thereof are arranged in parallel, for example, in the vertical direction, the electrodes as heat generating sources do not gather on the same side. This prevents the generation of a temperature difference between the right side and the left side of the box 913. As a result, it is possible to prevent the brightness of the backlight unit 912 from becoming uneven, which would occur when it is affected by the mercury vapor pressure of the lamps.

Furthermore, an insulating plate 917 made of polycarbonate is provided between the box 913 and the lamp holders 915, 916 to insulate the box 913 and the lamp holders 915, 916. In the present embodiment, the lamp holders 915 in the approximate shape of character U, to which, for example, electrically connected terminals 30a of lamps La1 and La2, or electrically connected terminals 30a of lamps La7 and La8 are connected, are welded to a metal base plate 915d. It should be noted here that although in the present embodiment, a plurality of lamp holders 915, each of which is formed in the approximate shape of character U to form a space that fits the contour of the lamp, are welded to a metal base plate 915d, the lamp holders and the metal base plate may be formed as one unit by cutting one plate and uprearing the holding plates 915a and 915b by a known method.

FIG. 24A shows an electric ballast provided in a lighting apparatus of the present invention. FIG. 24B shows a pattern of connections between a plurality of cold-cathode fluorescent lamps connected to the electric ballast. FIG. 24C shows another pattern of connections between a plurality of cold-cathode fluorescent lamps connected to the electric ballast.

As shown in FIG. 24A, the electric ballast 940 includes, for example: a DC (Direct-Current) power supply (VDC); capacitors C2 and C3 and switch elements Q1 and Q2 that are connected to the DC power supply, voltage step-up transformers T1 and T2 (or voltage step-up transformers T7 and T8); and an inverter (INV) control IC that supplies a gate signal to alternately turn ON/OFF the switch elements Q1 and Q2.

As shown in FIG. 24B, on the secondary side of the voltage step-up transformers, a series resonant circuit is formed by the leakage inductance of the secondary side of the transformers, the output from the transformers, and a parasitic capacitance that occurs to the inner surface 914 of the box 913 and to the lamps. The electric ballast 940 supplies sinusoidal wave currents, which have a phase difference of approximately 180 degrees, to the lamps La1 and La2 being adjacent to each other.

It should be noted here that the connection pattern of the plurality of lamps 1 is not limited to the pattern shown in FIG. 24B in which a pseudo-curved tube (tube in the approximate shape of character U) is formed by connecting lamp holders 915 holding electrically connected terminals 30a on one side of the adjacent lamps La1 and La2 in the lamp longitudinal direction, but may be a pattern in which the lamp holders connect electrically connected terminals of a pair of adjacent lamps at one end or at the other end of the arranged lamps. In the pattern shown in FIG. 24C, the lamp holders 915 and 916 are arranged in a houndstooth pattern such that among a plurality of fluorescent lamps 1 (which is composed of, for example, pairs of adjacent lamps La1 and La2, La2 and La3, La3 and La4, La11 and La12, and so on. The following describes only the pairs of adjacent lamps La1 and La2, La2 and La3, La3 and La4, for the sake of convenience), electrically connected terminals 30a of adjacent lamps La1 and La2 at one end (on the right-hand side) of the lamps are connected to each other, electrically connected terminals 30b of the next adjacent lamps La2 and La3 at the other end (on the left-hand side) of the lamps are connected to each other, and electrically connected terminals 30a of the next adjacent lamps La3 and La4 at one end (on the right-hand side) of the lamps are connected to each other. This construction makes the electric ballast further smaller, and makes it possible to perform the harness processing only by arranging the lamp holders 915 and 916 in a houndstooth pattern. That is to say, the construction reduces the harness processing since there is no need of wiring from the electric ballast to the lamp holders 915 and 916.

Back to FIG. 22, the opening of the box 913 is closed by a translucent panel 921 that is a stack of a diffusion plate 918 made of polycarbonate resin, a diffusion sheet 919, and a lens sheet 920 made of acrylic resin.

The diffusion plate 918 and the diffusion sheet 919 of the translucent panel 921 are provided to scatter and diffuse the light radiated from the lamps 1. The lens sheet 920 is provided to turn the light in the normal direction of the lens sheet 920. These elements are constructed so that the light emitted from the lamps 1 goes forward and evenly illuminates the whole surface (light emitting surface) of the front panel 921.

The backlight unit and the lighting apparatus in Embodiment 2 have a variety of advantageous effects: to form a pseudo-curved tube (tube in the approximate shape of character U) and reduce the number of inverters to half of before; to reduce, compared with conventional lamps having curved portions, the unevenness of brightness between the right side and the left side of the box in the longitudinal direction of the lamp; to prevent the sealing portion or the like of the lamp 1 from breaking; and to attach or detach the cold-cathode fluorescent lamp easily with a single touch. The backlight unit and the lighting apparatus having such advantageous effects are useful as lighting apparatuses, liquid crystal display apparatus, liquid crystal displays or the like.

### Modification to Lighting Apparatus in Embodiment 2

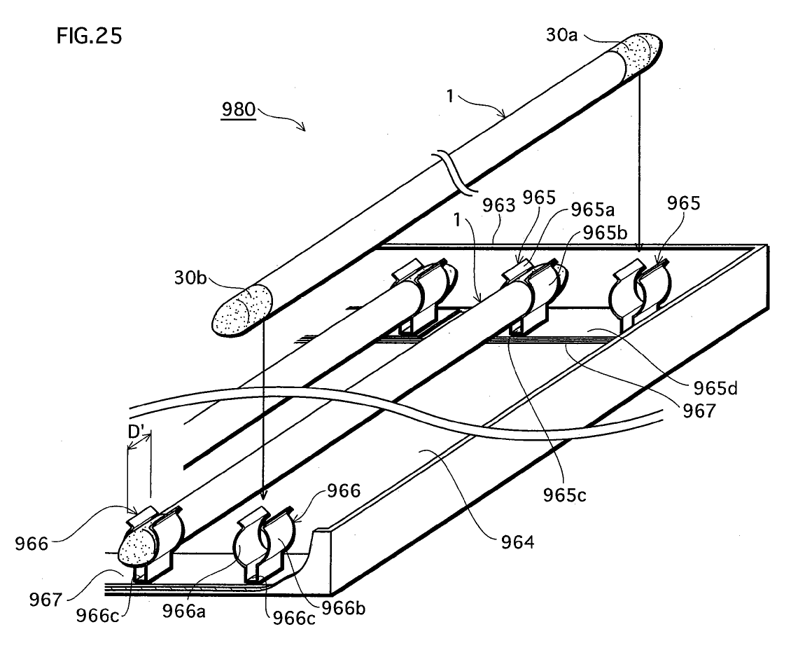

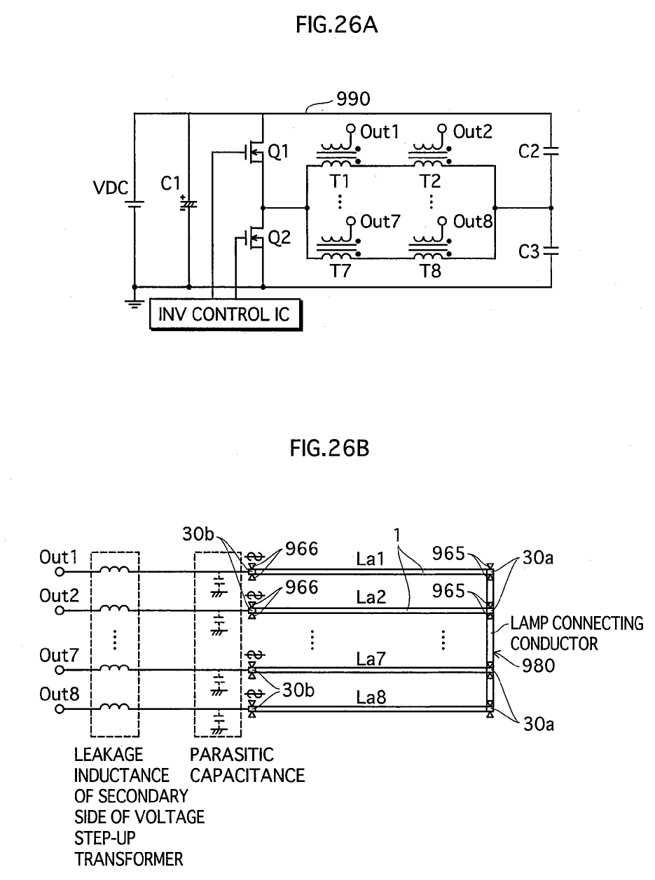

A lighting apparatus 980 in this modification includes the following, as shown in FIGS. 25 and 26B. Provided inside a box 963 are conductive lamp holders 965 and 966 each pair of which is disposed at positions at which a lamp 1 is attached, and provided outside the box 963 is an electric ballast 990 (see FIG. 26A) as an electric ballast for lighting each lamp 1 connected to each pair of lamp holders 965 and 966.

The lamp holders 965 and 966 are electrically conductive, and each of the lamp holders 965 and 966 is formed by, for example, bending a plate made of stainless or phosphor bronze. Each lamp holder 965 (966) is composed of: holding plates 965a and 965b (966a and 966b); and a linking piece 965c (966c) that links the holding plates 965a and 965b (966a and 966b) at the lower edges thereof. The holding plates 965a and 965b (966a and 966b) are shaped to be concave sideways to form a space that fits the contour of the electrically connected terminals 30a and 30b of the lamp 1. With this construction, when the lamp 1 is fitted in the space between the holding plates 965a and 965b (966a and 966b), the lamp 1 is held by the lamp holder 965 (966) by the elastic force of the holding plates 965a and 965b (966a and 966b) as springs, and at the same time, the lamp holders 965 and 966 are electrically connected to the electrically connected terminals 30a and 30b, respectively. It should be noted here that to prevent a corona discharge from occurring during the lamp lighting, the width D′ of the holding portions of the lamp holders 965 and 966 is designed so that the holding portions are within the electrically connected terminals 30a and 30b, which are provided at both ends of the lamp 1, in terms of the length in the tube axis direction of the lamp 1.

To each lamp 1 attached to the backlight unit 962, power is supplied from the electric ballast 990 shown in FIG. 26A via the lamp holders 965 and 966.

Here, the plurality of lamps 1 are arranged substantially in parallel at regular intervals such that each of the lamps 1 is held by a pair of lamp holders 965 and 966, and such that lamp holders 965 holding electrically connected terminals 30a of two adjacent lamps 1 (in FIG. 26B, electrically connected terminals 30a of lamps La1, La2, La7, La8 and so on) are connected to a ground connection side, and lamp holders 966 holding electrically connected terminals 30b of two adjacent lamps 1 (in FIG. 26B, electrically connected terminals 30b of lamps La1, La2, La7, La8 and so on) are connected to a high-voltage side of the electric ballast 990.

With this construction, in which lamp holders 965 holding electrically connected terminals 30a of two adjacent lamps 1 are connected to a ground connection side, it is possible, as is the case with the cold-cathode fluorescent lamps in the approximate shape of character U, to reduce the harness processing, and to reduce the unevenness of brightness between opposite ends of the arranged lamps since the lamp length is reduced to approximately half of before. It is also possible to prevent the sealing portion or the like of the lamp 1 from breaking since the lamp 1 can be attached and connected easily with a single touch to the lamp holders 965 and 966 in the box 963 of the backlight unit 962. Also, it is possible to reduce the harness processing in which the lead wire 22 outside both ends of the lamp 1 is connected, by soldering, to the lead wire 22 from the lighting apparatus 980. Also, with this construction in which the lamps 1 in the shape of straight tubes having electrodes 20 at both ends thereof are arranged in parallel, for example, in the vertical direction, the electrodes 20 as heat generating sources do not gather on the same side. This prevents the generation of a temperature difference between the right side and the left side of the box 963. As a result, it is possible to prevent the brightness of the backlight unit 962 from becoming uneven, which would occur when it is affected by the mercury vapor pressure of the lamps.

Typically, the electric ballast is constructed such that the phase difference between the voltages applied to two adjacent lamp holders 966 is set to approximately 180 degrees. However, not limited to this, the phase difference between the voltages applied to two adjacent lamp holders 966 may be set to approximately 0 degree. When the phase difference is approximately 0 degree, each potential difference between voltages applied to two adjacent lamp holders 966 becomes the same, and thus it is possible to decrease the distance between two adjacent lamps 1, compared with the case where the phase difference is approximately 180 degrees. In the present embodiment, the phase difference between the voltages is set to approximately 0 degree, and to further reduce the harness processing, all the lamp holders 965 holding and connecting to the electrically connected terminals 30a at one end in the longitudinal direction of the arranged lamps La1 to La8 are all grounded, as one example.

Furthermore, an insulating plate 967 made of polycarbonate is provided between the box 963 and the lamp holders 965, 966 to insulate the box 963 and the lamp holders 965, 966. In the present embodiment, the lamp holders 965 in the approximate shape of character U and on the ground connection side are welded to a metal base plate 965d. However, not limited to this, the lamp holders and the metal base plate may be formed as one unit by cutting one plate and uprearing the holding plates 965a and 965b by a known method.

FIG. 26A shows an electric ballast provided in a lighting apparatus of a modification of the present invention. FIG. 26B shows a pattern of connections between a plurality of cold-cathode fluorescent lamps connected to the electric ballast.

As shown in FIG. 26A, the electric ballast 990 includes, for example: a DC (Direct-Current) power supply (VDC); capacitors C2 and C3 and switch elements Q1 and Q2 that are connected to the DC power supply, voltage step-up transformers T1 and T2 (or voltage step-up transformers T7 and T8); and an inverter (INV) control IC that supplies a gate signal to alternately turn ON/OFF the switch elements Q1 and Q2.

As shown in FIG. 26B, on the secondary side of the voltage step-up transformers, a series resonant circuit is formed by the leakage inductance of the secondary side of the transformers, the output from the transformers, and a parasitic capacitance that occurs to the inner surface 964 of the box 963 and to the lamps. The electric ballast 990 supplies sinusoidal wave currents, which have the same phase, to the lamps La1 and La2 being adjacent to each other.

The lighting apparatus in the present modification has a variety of advantageous effects: to reduce, as is the case with the cold-cathode fluorescent lamps in the approximate shape of character U, the harness processing, and to reduce the unevenness of brightness between the right side and the left side of the outer container in the longitudinal direction of the lamp; to prevent the sealing portion or the like of the cold-cathode fluorescent lamp from breaking; and to attach and connect the cold-cathode fluorescent lamp easily with a single touch to the box of the backlight unit, and the lighting apparatus having such advantageous effects are useful as lighting apparatuses, liquid crystal display apparatus, liquid crystal displays or the like.

### Construction of Liquid Crystal Display Apparatus

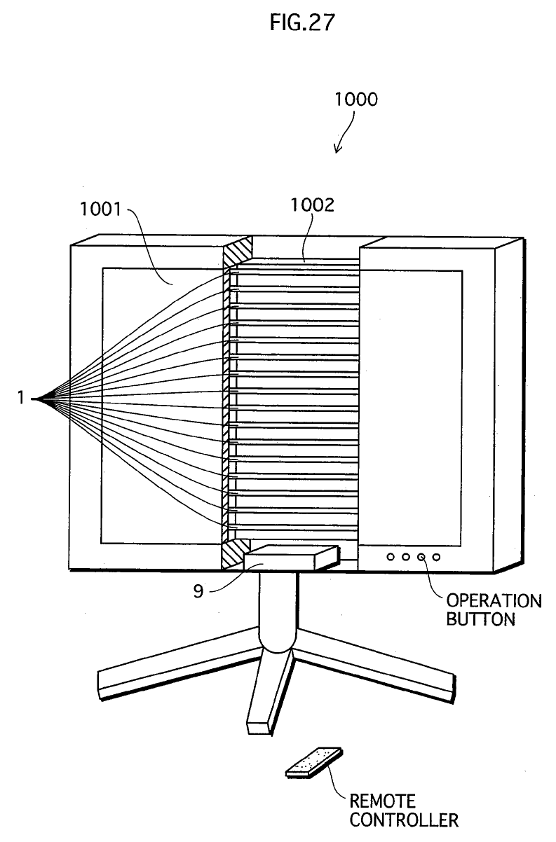

FIG. 27 shows a liquid crystal television as a liquid crystal display apparatus in an embodiment of the present invention.

A liquid crystal television 1000 shown in FIG. 27 is, for example, a 32-inch liquid crystal television, and includes a liquid crystal screen unit 1001 and a backlight unit 1002 of the present invention. The liquid crystal screen unit 1001 includes a color filter substrate, a liquid crystal, a TFT substrate, a drive module and so on (not illustrated), and forms color images based on image signals received from outside.

The present invention can broadly be applied to a cold-cathode fluorescent lamp, a lighting apparatus, a backlight unit, and a liquid crystal display apparatus.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

1.-20. (canceled)

21. A cold-cathode fluorescent lamp comprising:
a glass bulb;
a pair of hollow electrodes which each include an electrode body and a lead wire and are hermetically connected to the glass bulb at both ends of the glass bulb; and
a pair of electrically connected terminals being thin coats that are, except for connection portions thereof connected to lead wires, provided on an outer surface of the glass bulb at both ends thereof.

22. The cold-cathode fluorescent lamp of claim 21, wherein
the thin coats are 5 μm to 120 μm in thickness.

23. The cold-cathode fluorescent lamp of claim 21, wherein
the lead wire includes a projection portion projecting from the outer surface of the glass bulb in a direction of a tube axis of the glass bulb, the projection portion being connected to one of the electrically connected terminals and being 1 mm or less in length in the direction of the tube axis.

24. The cold-cathode fluorescent lamp of claim 21, wherein
in the electrically connected terminals, at least the connection portions are made of solder.

25. The cold-cathode fluorescent lamp of claim 21, wherein
the glass bulb is made of soda glass in which a rate of content of sodium oxide is 3% to 20%.

26. The cold-cathode fluorescent lamp of claim 21, wherein
in the glass bulb, a light extraction portion of a positive column light emitting portion is in a flattened shape in a cross section, and at least portions including the hollow electrodes are in a shape of a circle in a cross section, and the light extraction portion is longer than each of the portions including the hollow electrodes in the direction of the tube axis of the glass bulb.

27. The cold-cathode fluorescent lamp of claim 21, wherein
each of the electrically connected terminals includes:
a body layer that is formed on the outer surface of the glass bulb, and a major component thereof is silver or copper; and
an outer layer that is formed on an outer surface of the body layer.

28. The cold-cathode fluorescent lamp of claim 27, wherein
an end of the outer layer on a side of a center of the glass bulb is disposed with a distance away from an end of the body layer on the side of the center of the glass bulb, towards an end of the glass bulb opposite to the center of the glass bulb.

29. The cold-cathode fluorescent lamp of claim 21, wherein
end portions of the electrically connected terminals on a side of a center of the glass bulb become smaller in thickness as the end portions are closer to the center of the glass bulb.

30. A backlight unit comprising the cold-cathode fluorescent lamp recited in claim 21 as a light source.

31. A liquid crystal display apparatus comprising the backlight unit recited in claim 30.

32. A lighting apparatus comprising:
the cold-cathode fluorescent lamp recited in claim 21;
lamp holders that are provided in a box such that a contour of the electrically connected terminals of the cold-cathode fluorescent lamp is held, and are electrically connected to the cold-cathode fluorescent lamp; and
an electric ballast that is connected to the lamp holders and causes the cold-cathode fluorescent lamp to be lighted, wherein
the lamp holders hold a plurality of cold-cathode fluorescent lamps each of which is the cold-cathode fluorescent lamp recited in claim 21, such that the plurality of cold-cathode fluorescent lamps are arranged substantially in parallel at regular intervals, and such that lamp holders, which hold electrically connected terminals of two cold-cathode fluorescent lamps adjacent to each other at one end in a longitudinal direction of the arranged plurality of cold-cathode florescent lamps, are connected to each other.

33. The lighting apparatus of claim 32, wherein
the lamp holders are arranged in a houndstooth pattern such that
lamp holders holding first two cold-cathode fluorescent lamps adjacent to each other connect electrically connected terminals of the first two cold-cathode fluorescent lamps at one end of the plurality of cold-cathode fluorescent lamps arranged in parallel,
lamp holders holding second two cold-cathode fluorescent lamps adjacent to each other connect electrically connected terminals of the second two cold-cathode fluorescent lamps at another end of the plurality of cold-cathode fluorescent lamps arranged in parallel, and
lamp holders holding third two-cathode fluorescent lamps adjacent to each other connect electrically connected terminals of the third two cold-cathode fluorescent lamps at said one end of the plurality of cold-cathode fluorescent lamps arranged in parallel.

34. A lighting apparatus comprising:
the cold-cathode fluorescent lamp recited in claim 21;
lamp holders that are electrically conductive and are provided in a box such that the electrically connected terminals provided at both ends of the cold-cathode fluorescent lamp are connected to each other;
an electric ballast that is connected to the lamp holders and causes the cold-cathode fluorescent lamp to be lighted, wherein
the lamp holders hold a plurality of cold-cathode fluorescent lamps each of which is the cold-cathode fluorescent lamp recited in claim 21, such that the plurality of cold-cathode fluorescent lamps are arranged substantially in parallel, and such that at least one of lamp holders connected to the electrically connected terminals of two cold-cathode fluorescent lamps adjacent to each other is connected to a ground connection side, and each lamp holder at another end of the plurality of cold-cathode fluorescent lamps is connected to a high-voltage side of the electric ballast.

35. The lighting apparatus of claim 34, wherein
a phase difference between voltages applied to adjacent two lamp holders, connected to the high-voltage side of the electric ballast, is approximately 0 degrees.
